(19) United States
(12) Patent Application Publication
(10) Pub. No.: US 2017/0227364 A1
(43) Pub. Date: Aug. 10, 2017

(54) INFORMATION PROCESSING APPARATUS AND TRAJECTORY INFORMATION GENERATING METHOD

(71) Applicant: FUJITSU LIMITED, Kawasaki-shi (JP)

(72) Inventors: TAKASHI MIURA, Kawasaki (JP); Makiko Konoshima, Kawasaki (JP); Yui Noma, Kawasaki (JP)

(73) Assignee: FUJITSU LIMITED, Kawasaki-shi (JP)

(21) Appl. No.: 15/375,915

(22) Filed: Dec. 12, 2016

(30) Foreign Application Priority Data
Feb. 10, 2016 (JP) 2016-023308

(51) Int. Cl. G01C 21/30

(52) U.S. Cl. CPC G01C 21/30

(57) ABSTRACT

A memory stores second trajectory data indicating a plurality of reference positions, and road data indicating which road each of the reference positions belongs to. A processor acquires first trajectory data associating a plurality of times with a plurality of measured positions of a moving object, and velocity data indicating a moving velocity of the moving object at each of the times. The processor detects a first measured position where the moving velocity is equal to or less than a threshold. The processor extracts two or more reference positions located in a predetermined range from the first measured position. The processor complements the first trajectory data with information on roads corresponding to the respective times, by determining which road is to be associated with a time of measurement of the first measured position, based on the two or more reference positions and the road data.

### CROSS-REFERENCE TO RELATED APPLICATION

This application is based upon and claims the benefit of priority of the prior Japanese Patent Application No. 2016-023308, filed on Feb. 10, 2016, the entire contents of which are incorporated herein by reference.

### FIELD

The embodiments discussed herein are related to an information processing apparatus and a trajectory information generating method.

### BACKGROUND

The position of a moving object such as a vehicle may be measured using a positioning system such as the Global Positioning System (GPS). The position is expressed in latitude and longitude, for example. However, the position measured by a positioning system may have an error ranging roughly from 10 to several tens of meters. In view of this, there has been proposed a technique of map matching that matches measured positions to a road map so as to determine on which road the moving object is present (for example, on which road a vehicle is traveling, or on which road a vehicle was traveling at the time of measurement).

For example, there has been proposed a movement trajectory analysis apparatus that analyzes the movement trajectory of a moving object. The proposed movement trajectory analysis apparatus stores in advance a plurality of comparison movement trajectories in a storage device. The movement trajectory analysis apparatus calculates the similarity between a movement trajectory under analysis and each of the comparison movement trajectories, and selects and outputs the comparison movement trajectory with the greatest similarity as the analysis result. Each of the plurality of comparison movement trajectories and the movement trajectory under analysis is represented as a sequence of position coordinates. An algorithm such as dynamic time warping (DTW) is used to measure the similarity.

There has also been proposed a navigation apparatus that performs map matching, for example. The proposed navigation apparatus compares a travel trajectory representing changes in the position of a vehicle measured using the GPS with the shape of each of a plurality of roads on a road map, and determines the road with the highest correlation as a road on which the vehicle is traveling. If the navigation apparatus detects that the road with the highest correlation is changed to another road while the vehicle is traveling, the navigation apparatus determines that there is an error in previous map matching, and stores information on the travel trajectory and roads related to the error in the storage device. In subsequent map matching, the navigation apparatus refers to the stored information to prevent such an error from occurring again.

There has also been proposed a position information providing apparatus that estimates the current position of a terminal apparatus by using autonomous navigation, for example. The proposed position information providing apparatus acquires sensor data including angular velocity, acceleration, azimuth, and the like from sensors such as a gyro sensor, an acceleration sensor, an electronic compass, and the like. Then, the position information providing apparatus estimates the current position of a terminal apparatus based on the sensor data. Further, the position information providing apparatus calculates a feature amount such as the average value, the maximum value, the minimum value, and the like of the acquired sensor data. Then, the position information determines that the reliability is high if the feature amount is within a predetermined range, and determines that the reliability is low if the feature amount is out of the predetermined range. When the reliability is high, the position information providing apparatus displays detailed information on a small area around the current position. When the reliability is low, the position information providing apparatus displays general information on a large area.

See, for example, Japanese Laid-open Patent Publication No. 2006-352626, Japanese Laid-open Patent Publication No. 2008-145142, and International Publication Pamphlet No. WO2012/070595.

As described above, map matching may be performed using a method that searches for the most similar comparison movement trajectory to the movement trajectory of a moving object from among a plurality of comparison movement trajectories, and determines two or more roads through which the moving object passed, based on the found comparison movement trajectory. By associating one point (comparison position) contained in the comparison movement trajectory with one point (measured position) contained in the movement trajectory of the moving object, it is possible to specify a single road on which the moving object was present at a certain time.

The moving object often moves at a low speed in the vicinity of a place where a plurality of roads connect to each other, such as an intersection and the like. The position measured using a positioning system may have an error ranging roughly from 10 to several tens of meters. If the moving object moves at a low speed, the reliability of the positional relationship between the position measured at a certain time and the position measured shortly before or after the certain time is reduced due to the error. Therefore, the problem is how to specify a road on which the moving object was present at a certain time, from among two or more roads through which the comparison movement trajectory passes.

### SUMMARY

According to one aspect of the invention, there is provided an information processing apparatus that includes: a memory configured to store second trajectory data and road data, the second trajectory data indicating a plurality of reference positions, the road data indicating which of two or more roads each of the plurality of reference positions belongs to; and a processor configured to perform a procedure including: acquiring first trajectory data and velocity data, the first trajectory data associating a plurality of times with a plurality of measured positions of a moving object, the velocity data indicating a moving velocity of the moving object at each of the plurality of times, detecting a first measured position where the moving velocity is equal to or less than a threshold, from among the plurality of measured positions indicated in the first trajectory data, based on the velocity data, extracting two or more reference positions located in a predetermined range from the first measured position, from among the plurality of reference positions indicated in the second trajectory data, and complementing the first trajectory data with information on roads corresponding to the respective times, by determining which of the two or more roads is to be associated with a time of measurement of the first measured position, based on the extracted two or more reference positions and the road data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing apparatus according to a first embodiment;

FIG. 2 illustrates an example of a traffic analysis system according to a second embodiment;

FIG. 3 is a block diagram illustrating an example of hardware of a vehicle-mounted apparatus;

FIG. 4 is a block diagram illustrating an example of hardware of a traffic analysis apparatus;

FIG. 5 illustrates an example of map matching using reference trajectories;

FIG. 6 illustrates an example of similarity calculation between a query trajectory and a reference trajectory;

FIG. 7 illustrates another example of similarity calculation between a query trajectory and a reference trajectory;

FIG. 8 is a block diagram illustrating exemplary functions of the traffic analysis apparatus;

FIG. 9 illustrates an example of query data;

FIG. 10 illustrates an example of map data;

FIG. 11 illustrates an example of reference data;

FIG. 12 illustrates an example of search result data;

FIG. 13 illustrates an example of matching result data;

FIG. 14 is a flowchart illustrating an exemplary procedure of map matching;

FIG. 15 illustrates a first example of selecting a reference point;

FIG. 16 illustrates a second example of selecting a reference point;

FIG. 17 is a flowchart illustrating a first exemplary procedure of road determination;

FIG. 18 illustrates a third example of selecting a reference point;

FIG. 19 is a flowchart illustrating a second exemplary procedure of road determination;

FIG. 20 illustrates a fourth example of selecting a reference point;

FIG. 21 is a flowchart illustrating a third exemplary procedure of road determination;

FIG. 22 illustrates a fifth example of selecting a reference point; and

FIG. 23 is a flowchart illustrating a fourth exemplary procedure of road determination.

### DESCRIPTION OF EMBODIMENTS

Several embodiments will be described below with reference to the accompanying drawings, wherein like reference numerals refer to like elements throughout.

### (a) First Embodiment

The following describes a first embodiment.

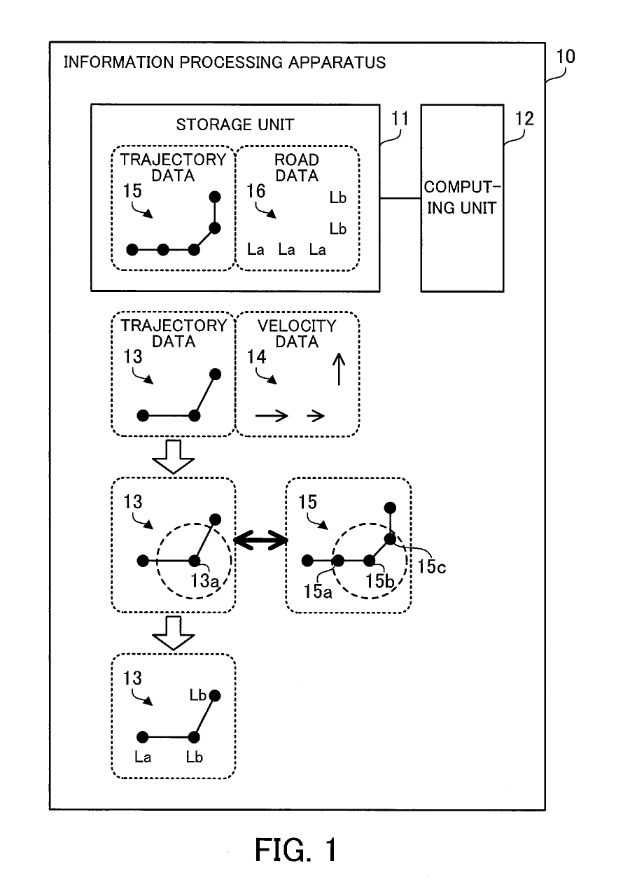

FIG. 1 illustrates an example of an information processing apparatus according to a first embodiment.

An information processing apparatus 10 of the first embodiment performs map matching for a moving object such as a vehicle and the like, and determines on which road the moving object was present at each time. The information processing apparatus 10 may be a server apparatus that collects data from the moving object and analyzes the data. In this case, the information processing apparatus 10 may be applied to a traffic control system. The information processing apparatus 10 may also be a terminal apparatus operated by the user. In this case, the information processing apparatus 10 may be mounted in the moving object.

The information processing apparatus 10 includes a storage unit 11 and a computing unit 12.

A database is created in the storage unit 11. The storage unit 11 may be a volatile semiconductor memory such as a random access memory (RAM) and the like, or may be a non-volatile storage device such as a hard disk drive (HDD), a flash memory, and the like. Although in the first embodiment the information processing apparatus 10 includes a database, the information processing apparatus 10 may refer to a database provided outside the information processing apparatus 10.

The computing unit 12 performs map matching. The computing unit 12 is, for example, a processor such as a central processing unit (CPU), a digital signal processor (DSP), and the like. However, the computing unit 12 may include an application specific electronic circuit such as an application specific integrated circuit (ASIC), a field programmable gate array (FPGA), and the like. The processor executes programs stored in a memory such as a RAM and the like (or the storage unit 11). The programs include a trajectory information generating program describing the procedure that will be described below. A set of multiple processors (a multiprocessor) may also be referred to as a “processor”.

The storage unit 11 stores trajectory data 15 (second trajectory data) and road data 16. The trajectory data 15 indicates a plurality of reference positions. Each reference position is represented by coordinates such as a pair of latitude and longitude, for example. The road data indicates which of two or more roads each of the plurality of reference positions belongs to. Each road is represented by identification information given to that road, for example.

The computing unit 12 acquires trajectory data (first trajectory data) and velocity data 14 of a moving object. The trajectory data 13 and the velocity data 14 may be generated by a terminal apparatus (for example, a vehicle-mounted apparatus such as a navigation apparatus) mounted in the moving object.

The trajectory data 13 associates a plurality of times with a plurality of measured positions of the moving object. Each measured position indicates the position of the moving object measured at a certain time using a positioning system such as the GPS, for example. However, each measured position may have an error ranging roughly from 10 to several tens of meters. Each measured position is represented by coordinates such as a pair of latitude and longitude, for example. The velocity data 14 indicates a moving velocity of the moving object at each of the plurality of times. Each moving velocity is measured using a measurement instrument of the moving object (for example, a speedometer of the vehicle), for example. However, the moving velocity may be estimated from the difference in measured position and the measurement interval.

The computing unit 12 detects a measured position 13a (first measured position) where the moving velocity at the time of measurement is equal to or less than a threshold, from among the plurality of measured positions indicated in the trajectory data 13, based on the velocity data 14. The measured position 13a is a position measured when the moving object was moving at a low speed. The threshold is a criterion for determining whether the relationship between a position measured at a certain time and a position measured shortly before or after the certain time is unclear due to an error and has a low reliability. The threshold may be a value obtained by dividing an expected value of the error by the measurement interval, for example. The computing unit 12 may determine whether the moving velocity is low by comparing the product of the moving velocity and the measurement interval (the unit moving distance) with the expected value of the error. The expected value of the error is 10 meters, for example.

Then, the computing unit 12 extracts reference positions 15a, 15b, and 15c located in a predetermined range from the detected measured position 13a, from among the plurality of reference positions indicated in the trajectory data 15. The predetermined range is set to a range of reference positions that may correspond to the measured position 13a, in consideration of the error, for example. The computing unit 12 determines which of the two or more roads is to be associated with the time of measurement of the measured position 13a, based on the reference positions 15a, 15b, and 15c and the road data 16.

There may be various methods to determine a road. For example, the computing unit 12 calculates the distance between the measured position 13a and each of the reference positions 15a, 15b, and 15c, and selects the reference position whose distance is the closest to the average value of the distance, from among the reference positions 15a, 15b, and 15c. As another example, the computing unit 12 calculates the average position of the reference positions 15a, 15b, and 15c, and selects the nearest reference position to the average position. As another example, the computing unit 12 calculates the distance between the measured position 13a and each of the reference positions 15a, 15b, and 15c, and selects the reference position with the closest distance to the expected error. Error data on the expected error in the area indicated by the trajectory data 15 may be stored in the storage unit 11. The computing unit 12 associates a road to which the selected reference position (first reference position) belongs with the time of measurement of the measured position 13a.

With the association process described above, it is possible to specify a single road on which the moving object was present at the time of measurement of the measured position 13a. For example, from among roads La and Lb indicated in the road data 16, the road Lb is specified. The specified road may be different from a road to which the nearest reference position from the measured position 13a belongs. Note that, as for each of the other measured positions where the moving velocity is greater than the threshold, the computing unit 12 may select the nearest reference position from that other measured position, and associate a road to which the selected reference position belongs with the time of measurement of that other measured position.

As a result, the trajectory data 13 is complemented with information on roads corresponding to the respective times. The complemented trajectory data 13 indicates the estimation results of roads on which the moving object was present at the respective times. The complemented trajectory data 13 may be used for various applications such as traffic control and the like.

According to the information processing apparatus 10 of the first embodiment, the measured position 13a where the moving velocity is low is detected from among the plurality of measured positions indicated in the trajectory data 13, based on the velocity data 14. The reference positions 15a, 15b, and 15c located in a predetermined range from the measured position 13a are extracted from among the plurality of reference positions indicated in the trajectory data 15. Based on the reference positions 15a, 15b, and 15c and the road data 16, a road to be associated with the time of measurement of the measured position 13a is determined, and the trajectory data 13 is complemented with information on roads corresponding to the respective times.

Accordingly, it is possible to specify a single road on which the moving object was present at each time. Further, when specifying a road on which the moving object moved at a low speed, the effect of the error in the measured position is taken into consideration. Thus, compared to a method that selects a road corresponding to the nearest reference position to a measured position without taking into consideration the moving velocity, it is possible to more appropriately associate a road with each time.

### (b) Second Embodiment

The following describes a second embodiment.

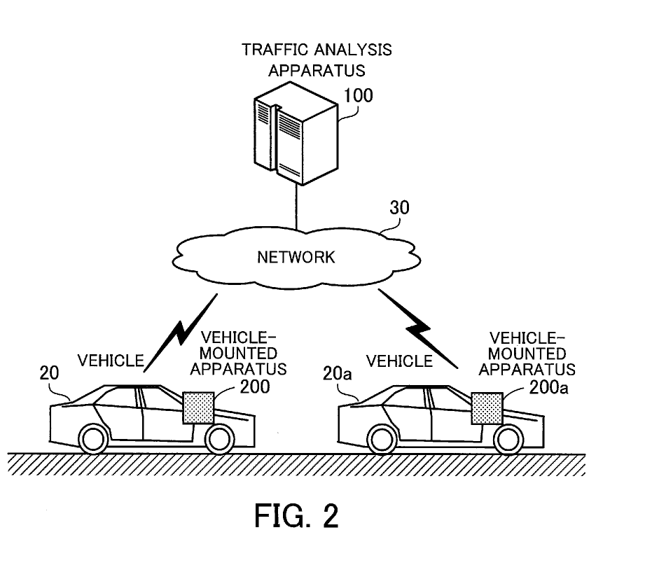

FIG. 2 illustrates an example of a traffic analysis system according to a second embodiment.

A traffic analysis system of the second embodiment includes a plurality of vehicles including vehicles 20 and 20a, a network 30, and a traffic analysis apparatus 100. The traffic analysis apparatus 100 corresponds to the information processing apparatus 10 of the first embodiment.

Each of the vehicles 20 and 20a may be a four-wheel vehicle driven by a person, for example. A vehicle-mounted apparatus 200 is mounted in the vehicle 20. A vehicle-mounted apparatus 200a is mounted in the vehicle 20a. Each of the vehicle-mounted apparatuses 200 and 200a may be an embedded apparatus that performs travel control, Or may be a terminal apparatus such as a navigation apparatus and the like, operated by the user. The vehicle-mounted apparatuses 200 and 200a are connected to the network 30 through a radio link.

The vehicle-mounted apparatus 200 measures the position of the vehicle 20 by using the GPS. The vehicle-mounted apparatus 200 also measures the velocity of the vehicle 20. The vehicle-mounted apparatus 200 transmits data indicating the position and the velocity of the vehicle 20 to the traffic analysis apparatus 100 via the network 30. Likewise, the vehicle-mounted apparatus 200a measures the position of the vehicle 20a by using the GPS. The vehicle-mounted apparatus 200a also measures the velocity of the vehicle 20a. The vehicle-mounted apparatus 200a transmits data indicating the position and the velocity of the vehicle 20a to the traffic analysis apparatus 100 via the network 30.

The traffic analysis apparatus 100 is a server apparatus that analyzes the travelling conditions of the vehicle on the road. The traffic analysis apparatus 100 is connected to the network 30. The traffic analysis apparatus 100 collects position and velocity data from each of the plurality of vehicles via the network 30. The traffic analysis apparatus 100 may be applied to a traffic control system. For example, the analysis results of the traffic analysis apparatus 100 may be used for traffic control such as traffic signal control and the like.

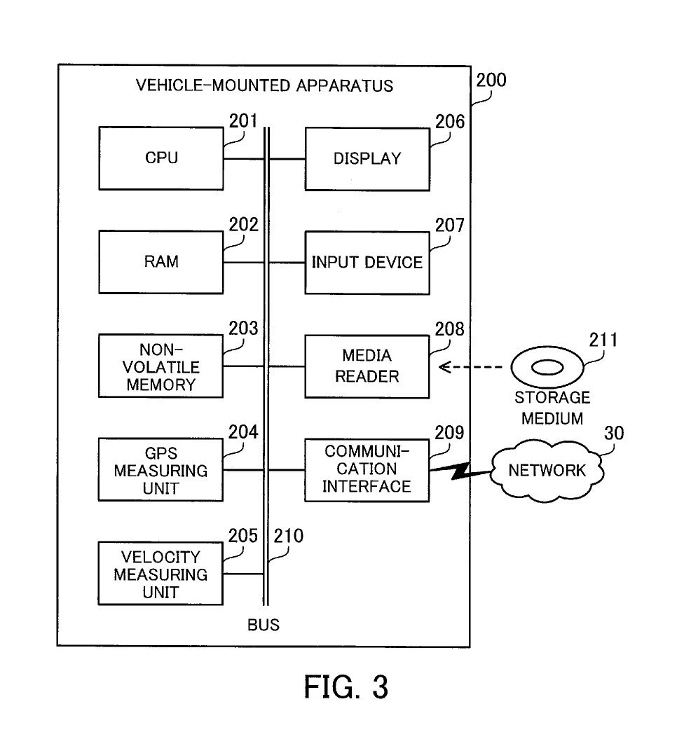

FIG. 3 is a block diagram illustrating an example of hardware of the vehicle-mounted apparatus 200.

The vehicle-mounted apparatus 200 includes a CPU 201, a RAM 202, a non-volatile memory 203, a GPS measuring unit 204, a velocity measuring unit 205, a display 206, an input device 207, a media reader 208, and a communication interface 209. These units included in the vehicle-mounted apparatus 200 are connected to a bus 210. The vehicle-mounted apparatus 200a may be implemented by the same hardware as that of the vehicle-mounted apparatus 200.

The CPU 201 is a processor including an arithmetic circuit that executes program instructions. The CPU 201 loads at least part of a program and data stored in the non-volatile memory 203 to the RAM 202, and executes the program.

The RAM 202 is a volatile semiconductor memory that temporarily stores a program executed by the CPU 201 and data used for operations by the CPU 201. The vehicle-mounted apparatus 200 may include other types of memories than a RAM, and may include a plurality of memories.

The non-volatile memory 203 is a non-volatile storage device that stores programs of software (such as an operation system (OS), driver software, application software, and the like) and data. The non-volatile memory 203 may be a read-only memory (ROM), or may be a rewritable memory such as a flash memory and the like. Further, the vehicle-mounted apparatus 200 may include another type of non-volatile storage device such as an HDD and the like, and may include a plurality of types of non-volatile storage devices.

The GPS measuring unit 204 periodically receives a GPS signal from a GPS satellite, and measures the position of the vehicle-mounted apparatus 200 based on the received GPS signal. The position of the vehicle-mounted apparatus 200 is represented by coordinates in the global coordinate system including longitude and latitude. In the second embodiment, the GPS measuring unit 204 measures the position of the vehicle-mounted apparatus 200 at 1-second intervals. The measured position is sampled at 1/10 and converted into information of a 10-second period by the CPU 201. Depending on the environment around the vehicle-mounted apparatus 200, the GPS measuring unit 204 is unable to successfully receive a GPS signal and may fail to measure the position. For example, when the vehicle 20 is indoors or underground, or when the vehicle 20 is surrounded by many tall buildings, the position measurement may fail. If so, the measurement results corresponding to that time is missing. Further, depending on the environment around the vehicle-mounted apparatus 200, the measured position may have an error of around 10 meters.

The velocity measuring unit 205 measures the velocity of the vehicle 20. The unit of velocity is kilometer/hour, for example. The velocity measuring unit 205 measures the velocity at least concurrently with the position measurement by the GPS measuring unit 204 (at 1-second intervals) or concurrently with the position measurement after sampling (at 10-second intervals). Note that the velocity measuring unit 205 may acquire information on the velocity from a speed meter provided outside the vehicle-mounted apparatus 200.

The display 206 displays an image in accordance with an instruction from the CPU 201. Examples of the display 206 include a liquid crystal display (LCD), an organic electro-luminescence (OEL) display, and the like. The display 206 may be a separate part of the vehicle-mounted apparatus 200.

The input device 207 detects an operation by the user, and outputs a signal indicating the detected operation to the CPU 201. Examples of the input device 207 include a keypad, a touch panel, and the like. The vehicle-mounted apparatus 200 may include a plurality of types of input devices. The input device 207 may be a separate part of the vehicle-mounted apparatus 200.

The media reader 208 is a reading device that reads a program and data stored in a storage medium 211. Examples of the storage medium 211 include a semiconductor memory, a magnetic disc (such as a flexible disk (FD), an HDD, and the like), an optical disc (such as a compact disc (CD), a digital versatile disc (DVD), and the like), a magneto-optical disc (MO), and the like. The media reader 208 reads, for example, a program and data from the storage medium 211, and stores the read program and data in the RAM 202 or the non-volatile memory 203.

The communication interface 209 is a radio communication interface that is connected to the network 30 through a radio link, and communicates with the traffic analysis apparatus 100 via the network 30. The communication interface 209 transmits, to the traffic analysis apparatus 100, data including the time, the coordinates measured by the GPS measuring unit 204, and the velocity measured by the velocity measuring unit 205 in association with each other, in accordance with an instruction from the CPU 201. The communication interface 209 may transmit the data at the same intervals as the sampling intervals of the coordinates (10-second intervals), or may transmit the data of a plurality of times together. For example, the communication interface 209 may transmit data of 30 times (10 seconds×30=300 seconds=5 minutes) every five minutes.

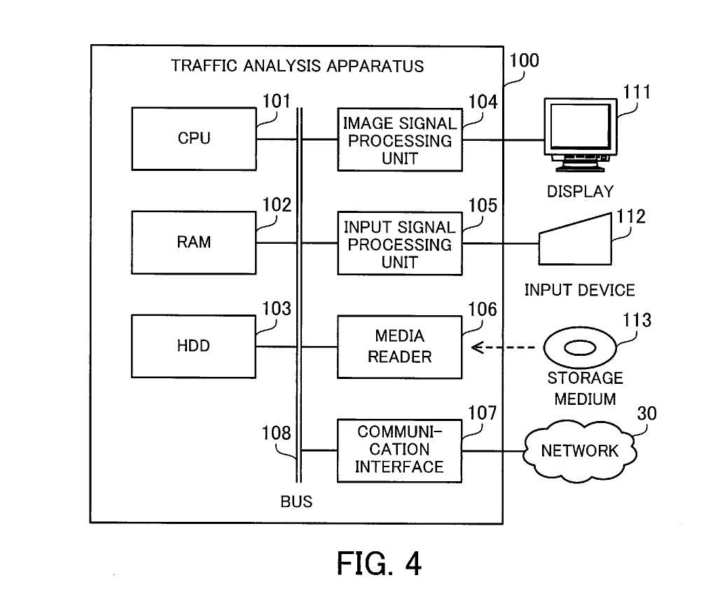

FIG. 4 is a block diagram illustrating an example of hardware of the traffic analysis apparatus 100.

The traffic analysis apparatus 100 includes a CPU 101, a RAM 102, an HDD 103, an image signal processing unit 104, an input signal processing unit 105, a media reader 106, and a communication interface 107. These units included in the traffic analysis apparatus 100 are connected to a bus 108. The CPU 101 corresponds to the computing unit 12 of the first embodiment. The RAM 102 or the HDD 103 corresponds to the storage unit 11 of the first embodiment.

The CPU 101 is a processor including an arithmetic circuit that executes program instructions. The CPU 101 loads at least part of a program and data stored in the HDD 103 to the RAM 102, and executes the program. Note that the CPU 101 may include multiple processor cores, and the traffic analysis apparatus 100 may include multiple processors. A set of multiple processors (a multiprocessor) may be referred to as a “processor”.

The RAM 102 is a volatile semiconductor memory that temporarily stores a program executed by the CPU 101 and data used for operations by the CPU 101.

The HDD 103 is a non-volatile storage device that stores software programs (such as an OS, middleware, application software, and the like) and data. The programs include a trajectory information generating program. The traffic analysis apparatus 100 may include another type of storage device such as a flash memory, a solid state drive (SSD), and the like.

The image signal processing unit 104 outputs an image to a display 111 connected to the traffic analysis apparatus 100, in accordance with an instruction from the CPU 101. The display 111 may be any type of display such as a cathode ray tube (CRT) display, an LCD, a plasma display, an OEL display, and the like.

The input signal processing unit 105 obtains an input signal from an input device 112 connected to the traffic analysis apparatus 100, and outputs the input signal to the CPU 101. Examples of the input device 112 include a pointing device (such as a mouse, a touch panel, a touch pad, a trackball, and the like), a keyboard, a remote controller, a button switch, and the like. A plurality of types of input devices may be connected to the traffic analysis apparatus 100.

The media reader 106 is a reading device that reads a program and data stored in a storage medium 113. Examples of the storage medium 113 include a magnetic disk, an optical disc, a magneto-optical disk, a semiconductor memory, and the like. The media reader 106 reads a program and data from the storage medium 113, and stores the read program and data in the RAM 102 or the HDD 103.

The communication interface 107 is an interface that is connected to the network 30 to communicate with other apparatuses via the network 30. The communication interface 107 may be a wired communication interface connected to a communication apparatus such as a switch via a cable, or may be a radio communication interface connected to a base station via a radio link.

The following describes map matching performed by the traffic analysis apparatus 100.

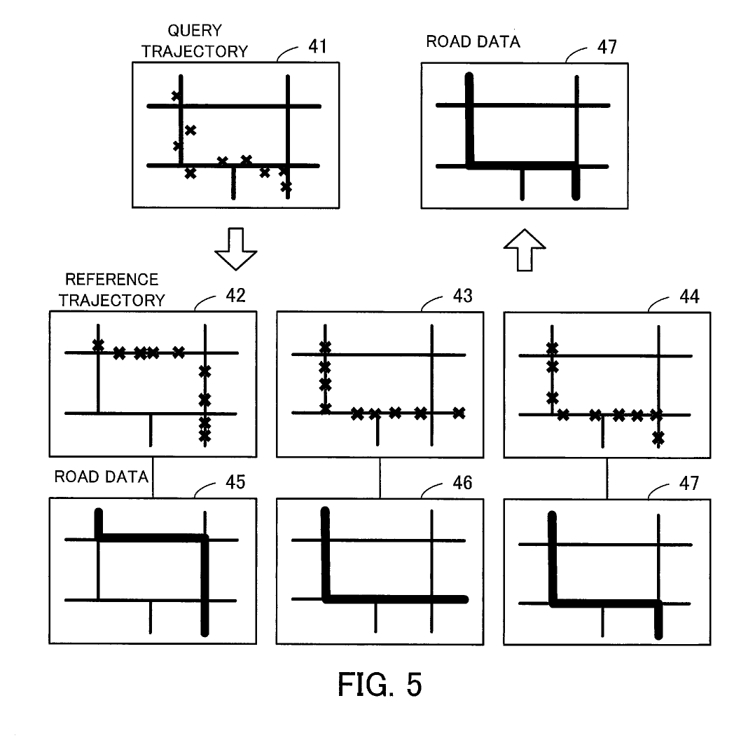

FIG. 5 illustrates an example of map matching using reference trajectories.

In the following, it is assumed that the traffic analysis apparatus 100 receives data from the vehicle-mounted apparatus 200 mounted in the vehicle 20, and determines on which road the vehicle 20 was present at each time based on the received data. The traffic analysis apparatus 100 acquires a query trajectory 41. The query trajectory 41 is a sequence of coordinates (measured positions) measured by the GPS during a 5-minute period. Note that each measured set of coordinates may have an error, and therefore does not always correctly indicate a point on a road. Also, in the query trajectory 41, sets of coordinates at some times may be missing due to failed measurement. In the case of the sampling interval described above, the query trajectory 41 contains a maximum of 30 sets of coordinates.

The traffic analysis apparatus 100 also has a database including a plurality of reference trajectories and a plurality of pieces of road data associated with the respective reference trajectories. For example, FIG. 5 illustrates reference trajectories 42 to 44, and pieces of road data 45 to 47. The road data 45 corresponds to the reference trajectory 42. The road data 46 corresponds to the reference trajectory 43. The road data 47 corresponds to the reference trajectory 44.

Each of the reference trajectories 42 to 44 is generated based on a sequence of coordinates measured during a 5-minute period when a certain vehicle (which may be a vehicle different from the vehicle 20) traveled in the past, and is a sequence of reference coordinates (reference positions). Each of the reference trajectories 42 to 44 contains a maximum of 30 sets of coordinates. The coordinates contained in the reference trajectories 42 to 44 are appropriate coordinates on roads that are obtained by correcting the coordinates measured in the past based on the results of previous map matching.

Each of the pieces of road data 45 to 47 is a sequence of road identifiers corresponding to a sequence of coordinates of a reference trajectory. Each of the pieces of road data 45 to 47 contains a maximum of 30 identifiers. The results of previous map matching are reflected to each road identifier contained in the pieces of road data 45 to 47 such that the road identifier indicates a road on which the vehicle was traveling at a certain time (a road to which the reference position belongs).

Each set of coordinates contained in the reference trajectory 42 corresponds to an identifier contained in the road data 45. Each set of coordinates contained in the reference trajectory 43 corresponds to an identifier contained in the road data 46. Each set of coordinates contained in the reference trajectory 44 corresponds to an identifier contained in the road data 47. The vehicle may travel a plurality of roads during a 5-minute period, and therefore each of the pieces of road data 45 to 47 may contain the identifiers of different roads.

Upon receiving the query trajectory 41, the traffic analysis apparatus 100 searches for the most similar reference trajectory to the query trajectory 41 from among the plurality of reference trajectories stored in the database. In the second embodiment, DTW is used in similarity search between trajectories. The details of similarity search will be described below. The traffic analysis apparatus 100 extracts road data corresponding to the found reference trajectory. In this example, the reference trajectory 44 is the most similar to the query trajectory 41, and therefore the road data 47 is extracted.

The traffic analysis apparatus 100 associates the identifier of one of roads included in the road data 47 with each set of coordinates contained in the query trajectory 41, that is, each time indicated in the query trajectory 41. In the similarity search, in the course of calculating the similarity, the corresponding relationships between the plurality of sets of coordinates contained in the query trajectory 41 and the plurality of sets of coordinates contained in the reference trajectory 44 is also calculated. Accordingly, the traffic analysis apparatus 100 finds the corresponding sets of coordinates in the reference trajectory 44 based on the sets of coordinates in the query trajectory 41, and then finds the identifies of roads in the road data 47 based on the corresponding sets of coordinates. Thus, it is possible to complement the query trajectory 41 with information on the road on which the vehicle 20 was traveling at each time. That is, it is possible to complete map matching for the query trajectory 41.

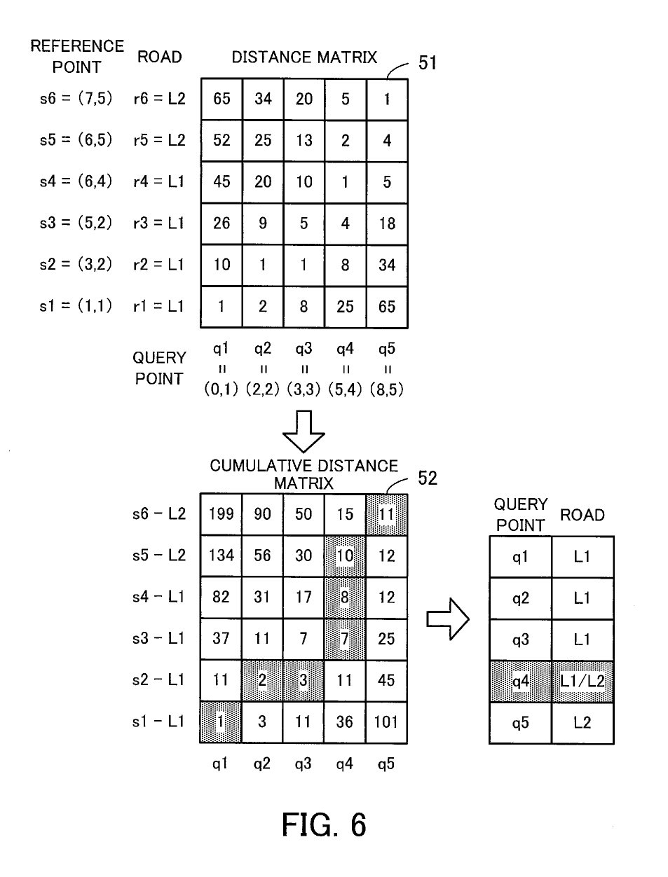

FIG. 6 illustrates an example of similarity calculation between a query trajectory and a reference trajectory.

The traffic analysis apparatus 100 calculates the similarity between a query trajectory and a reference trajectory by using DTW in the manner described below. The DTW distance is used as a measure of similarity. The smaller the DTW distance is, the greater the similarity between the query trajectory and the reference trajectory is; and the greater the DTW distance is, the less the similarity between the query trajectory and the reference trajectory is.

Upon comparing the query trajectory with the reference trajectory, the velocity of the vehicle at the time of generation of the query trajectory may be different from the velocity of the vehicle at the time of generation of the reference trajectory, and hence the distance between the adjacent sets of coordinates may differ between the query trajectory and the reference trajectory. Also, the pattern of acceleration and deceleration may differ between the query trajectory and the reference trajectory. On the other hand, if a method is used that compares the sets of coordinates in the query trajectory with the sets of coordinates in the reference trajectory on a one-to-one basis in order of sequence, the differences in velocity and acceleration greatly affect the similarity, which may reduce the accuracy of similarity search. In view of this, DTW allows expansion and compression of the time axis, and compares the sets of coordinates in the query trajectory with the sets of coordinates in the reference trajectory on a multiple-to-multiple basis.

For simplicity of explanation, it is assumed that the query trajectory is a sequence of query points q1 to q5, and the reference trajectory is a sequence of reference points s1 to s6. The number of query points is less than the number of reference points due to a failure in GPS measurement. For simplicity of explanation, it is assumed that the coordinates of five query points are q1=(0, 1), q2=(2, 2), q3=(3, 3), q4=(5, 4), and q5=(8, 5). Also, for simplicity of explanation, it is assumed that the coordinates of six reference points are s1=(1, 1), s2=(3, 2), s3=(5, 2), s4=(6, 4), s5=(6, 5), and s6=(7, 5). Roads r1 to r6 are associated with the reference points s1 to s6, respectively. Here, r1=r2=r3=r4=L1, and r5=r6=L2. As described below, L1 and L2 are the identifiers of roads. That is, the reference points s1 to s4 belong to the same road, and the reference points s5 and s6 belong to the same road.

First, the traffic analysis apparatus 100 calculates the distance for every combination of the query points and the reference points, and generates a distance matrix 51. In FIG. 6, the square of Euclidean distance is used as the “distance”. Accordingly, the “distance” may be calculated as the sum of the square of the difference in latitude and the square of the difference in longitude. For example, the distance between q1=(0, 1) and s1 (1, 1) is 1²+0²=1. The distance between q1=(0, 1) and s2=(3, 2) is 3²+1²=10. Note that the other measures such as the Euclidean distance, the Manhattan distance, and the like may be used as the “distance”. The distance matrix 51 represents 30 distances between the query points q1 to q5 and the reference points s1 to s6.

Then, the traffic analysis apparatus 100 generates an empty cumulative distance matrix 52, and fills the cumulative distance matrix 52 with values from the bottom left to the top right based on the distance matrix 51. In the cumulative distance matrix 52, column i is the column corresponding to an i-th (i=1 to 5) query point qi, and row j is the row corresponding to a j-th (j=1 to 6) reference point sj. Upon initializing the cumulative distance matrix 52, the value in row 0 and column 0 of the cumulative distance matrix 52 is set to 0; the values in row 0 and column 1 to row 0 and column 5 of the cumulative distance matrix 52 are set to infinity; and the values in row 1 and column 0 to row 6 and column 0 of the cumulative distance matrix 52 are set to infinity.

The value in row j and column i of the cumulative distance matrix 52 is defined as a value obtained by adding the value in row j and column i of the distance matrix 51 to the smallest one of three values in row j−1 and column i, row j and column i−1, and row j−1 and column i−1. The traffic analysis apparatus 100 determines the values sequentially from row 1 and column 1 to row 6 and column 1 of the cumulative distance matrix 52, in accordance with the above definition. When the first row is finished, the traffic analysis apparatus 100 sequentially determines the values in the second row, the third row, the fourth row, and the fifth row in the same manner.

For example, the value in row 1 and column 1 of the cumulative distance matrix 52 is determined as “1”, which is obtained by adding the value in row 1 and column 1 of the distance matrix 51 to the value in row 0 and column 0 of the cumulative distance matrix 52. The value in row 2 and column 1 of the cumulative distance matrix 52 is determined as “11”, which is obtained by adding the value in row 2 and column 1 of the distance matrix 51 to the value in row 1 and column 1 of the cumulative distance matrix 52. Then, in the same manner as described above, the values in row 3 and column 1 to row 6 and column 1 of the cumulative distance matrix 52 are determined as “37”, “82”, “134”, and “199”. Further, the value in row 1 and column 2 of the cumulative distance matrix 52 is determined as “3”, which is obtained by adding the value in row 1 and column 2 of the distance matrix 51 to the value in row 1 and column 1 of the cumulative distance matrix 52. The value in row 2 and column 2 of the cumulative distance matrix 52 is determined as “2”, which is obtained by adding the value in row 2 and column 2 of the distance matrix 51 to the value in row 1 and column 1 of the cumulative distance matrix 52. The value in row 3 and column 2 of the cumulative distance matrix 52 is determined as “11”, which is obtained by adding the value in row 3 and column 2 of the distance matrix 51 to the value in row 2 and column 2 of the cumulative distance matrix 52. Then, in the same manner as described above, the calculation is performed to reach row 6 and column 5 of the cumulative distance matrix 52. Thus, the value in row 6 and column 5 of the cumulative distance matrix 52 is determined as “11”.

The value in row 6 and column 5 at the top right of the cumulative distance matrix 52 is the DTW distance between the query trajectory and the reference trajectory. Accordingly, in the example of FIG. 6, the DTW distance is 11.

Further, the traffic analysis apparatus 100 detects the shortest path along which the cumulative distance increases monotonically from the left bottom to the top right of the cumulative distance matrix 52. On the shortest path, the next point of row j and column i may be chosen from the following three: row j+1 and column i, row j and column i+1, and row j+1 and column i+1. In the example of FIG. 6, the path that passes through row 1 and column 1, row 2 and column 2, row 2 and column 3, row 3 and column 4, row 4 and column 4, row 5 and column 4, and row 6 and column 5 of the cumulative distance matrix 52 is the shortest path. The shortest path represents the corresponding relationship obtained by associating the query points q1 to q5 and the reference points s1 to s6 with each other such that the query trajectory and the reference trajectory are approximated most closely to each other on the whole. Accordingly, the following associations are made: q1 and s1; q2 and s2; q3 and s2; q4 and s3 to s5; and q5 and s6.

The traffic analysis apparatus 100 assigns an identifier of a road to each query point, based on the corresponding relationships between the query points q1 to q5 and the reference points s1 to s6 calculated by DTW. That is, the traffic analysis apparatus 100 assigns, to a certain query, an identifier of a road that is associated with a reference point associated with the certain query point. Thus, it is possible to specify a road on which the vehicle 20 was traveling at each time of measurement of a query point. In the example of FIG. 6, L1 is assigned to the query points q1 to q3, and L2 is assigned to the query point q5.

However, in the example of FIG. 6, the reference points s3 to s5 are associated with the query point q4 by DTW. The identifier of the road associated with the reference points s3 and s4 is L1, while the identifier of the road associated with the reference point s5 is L2. Therefore, if based only on the results obtained by DTW, L1 and L2 are assigned to the query point q4, so that it is not possible to select a single road identifier. The same problem occurs even when there are the same number of query points and reference points.

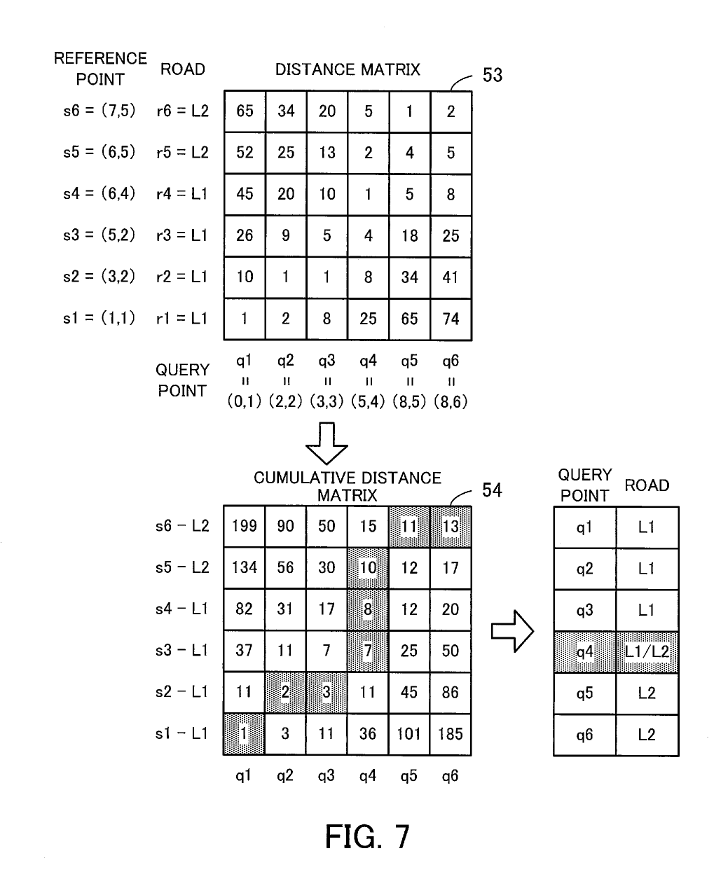

FIG. 7 illustrates another example of similarity calculation between a query trajectory and a reference trajectory.

In this example, the query trajectory is a sequence of query points q1 to q6, and the reference trajectory is a sequence of reference points s1 to s6. Unlike the example of FIG. 6, there are the same number of query points and reference points. The traffic analysis apparatus 100 calculates a distance matrix 53 between the query points q1 to q6 and the reference points s1 to s6, using the same calculation procedure as that used for the distance matrix 51. Then, the traffic analysis apparatus 100 calculates a cumulative distance matrix 54, using the same calculation procedure as that used for the cumulative distance matrix 52.

In the example of FIG. 7, the value in row 6 and column 6 at the top right of the cumulative distance matrix 54 is “13”. Accordingly, the DTW distance between the query trajectory and the reference trajectory is 13. Further, the following associations are made: q1 and s1; q2 and s2; q3 and s2; q4 and s3 to s5; q5 and s6; and q6 and s6. Accordingly, L1 is assigned to the query points q1 to q3, and L2 is assigned to the query points q5 and q6. However, as in the example of FIG. 6, the reference points s3 to s5 are associated with the query point q4. Therefore, if based only on the results obtained by DTW, L1 and L2 are assigned to the query point q4, so that it is not possible to select a single road identifier.

The following description of the second embodiment focuses on a measure to be taken when two or more reference points are associated with a single query point in similarity search using DTW. That is, the following description focuses on a method of selecting a single road as a road on which the vehicle 20 was traveling at each time.

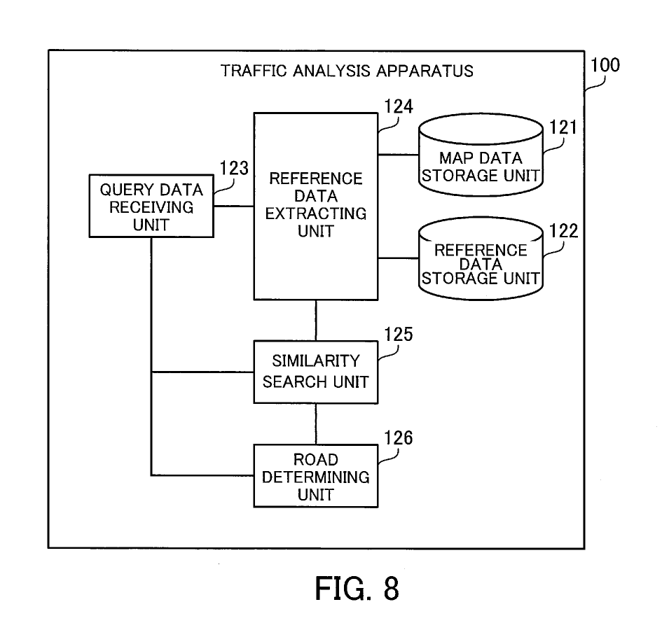

FIG. 8 is a block diagram illustrating exemplary functions of the traffic analysis apparatus 100.

The traffic analysis apparatus 100 includes a map data storage unit 121, a reference data storage unit 122, a query data receiving unit 123, a reference data extracting unit 124, a similarity search unit 125, and a road determining unit 126. The map data storage unit 121 and the reference data storage unit 122 are implemented using a storage area reserved in the RAM 102 or the HDD 103, for example. The query data receiving unit 123, the reference data extracting unit 124, the similarity search unit 125, and the road determining unit 126 are implemented using program modules executed by the CPU 101, for example.

The map data storage unit 121 stores map data representing a road map. The road map is split into a plurality of areas. Thus, the map data includes area data indicating a range of latitude and a range of longitude of each area. Further, roads on the road map are represented by nodes and links connecting two nodes. Each node represents a basic point such as an intersection and the like. The road on which each vehicle is present may be represented by an identifier of a link. Thus, the map data includes node data indicating the latitude and longitude of each node, and link data indicating each link.

The reference data storage unit 122 is a database created in the traffic analysis apparatus 100. The reference data storage unit 122 stores reference data on a plurality of reference trajectories. As mentioned above, the reference data may be generated based on query data collected from a plurality of vehicles in the past and the results of previous map matching. The reference data includes a sequence of coordinates as each reference trajectory. The coordinates of the reference trajectory are the coordinates on roads that are corrected by map matching. Each of the reference trajectories is split into a plurality of areas. The reference data also includes velocity data indicating the velocity of the vehicle at the time when each original set of coordinates was measured. The reference data also includes road data indicating which road each set of coordinates belongs to. The reference data also includes error data indicating an error (GPS measurement error) between the originally measured coordinates and the coordinates after correction.

The query data receiving unit 123 receives query data from each of the plurality of vehicles including the vehicles 20 and 20a. The query data includes a sequence of coordinates measured by the GPS as a query trajectory. The query trajectory associates a plurality of times with a plurality of sets of coordinates. For example, the sampling interval is 10 seconds, and the query trajectory is a sequence of a maximum of 30 sets of coordinates measured during a 5-minute period. The query data also includes velocity data indicating the velocity of the vehicle at the time when each set of coordinates was measured.

When the query data receiving unit 123 receives query data, the reference data extracting unit 124 extracts, from the reference data storage unit 122, reference data on the roads near the vehicle that has transmitted the query data. More specifically, the reference data extracting unit 124 acquires the last set of coordinates of the query trajectory, and specifies the area to which the last set of coordinates belongs by referring to the map data storage unit 121. The reference data extracting unit 124 extracts reference data on the specified area from the reference data storage unit 122. Then, the reference data extracting unit 124 compares the last set of coordinates of the query trajectory with the last set of coordinates of each reference trajectory, and selects and outputs reference data containing a reference trajectory whose last set of coordinates is present in a predetermined range from the last set of coordinates of the query trajectory.

The similarity search unit 125 compares the query trajectory contained in the query data with each of reference trajectories output by the reference data extracting unit 124, and calculates the similarity (DTW distance) of the reference trajectory by using DTW. The similarity search unit 125 selects the reference trajectory with the greatest similarity (the smallest DTW distance) from among the plurality of reference trajectories, and outputs the search result data. The search result data includes a sequence of coordinates as the selected reference trajectory, road data corresponding to the selected reference trajectory, velocity data corresponding to the selected reference trajectory, and error data corresponding to the selected reference trajectory. The search result data includes information indicating the corresponding relationships between the plurality of query points and the plurality of reference points obtained by DTW in the course of calculating the similarity.

The road determining unit 126 performs map matching so as to determine on which road the vehicle was traveling at each time, based on the query data and the search result data output by the similarity search unit 125. The road determining unit 126 generates matching result data containing the query data complemented with road identifiers. If only a single reference point is associated with a certain query point, the road determining unit 126 may select a single road associated with the single reference point. On the other hand, if two or more reference points are associated with a certain query point, the road determining unit 126 may need to select one of the two or more roads. In this case, the road determining unit 126 uses the velocity data included in the query data. The road determining unit 126 may further use the velocity data or error data included in the search result data.

The road determining unit 126 outputs matching result data. The matching result data may be displayed on the display 111. Further, the matching result data may be stored in the reference data storage unit 122. The details of processes performed by the road determining unit 126 will be described below. Note that in the second embodiment, a single reference trajectory with the greatest similarity is selected, and then road determination is performed. On the other hand, a plurality of reference trajectories with great similarities may be selected, and then road determination may be performed for each of the selected plurality of reference trajectories. The most suitable reference trajectory may be selected from among the plurality of reference trajectories, based on the results of the road determination.

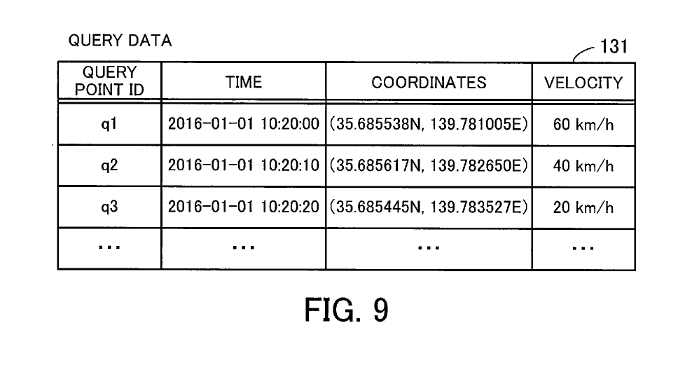

FIG. 9 illustrates an example of query data.

Query data 131 is received by the query data receiving unit 123 from the vehicle-mounted apparatus 200 mounted in the vehicle 20. The query data 131 has the following items: Query Point ID, Time, Coordinates, and Velocity. The Query Point ID indicates the identifier of a query point. The Time in the query data 131 indicates a time when the coordinates were measured by the GPS measuring unit 204. The Coordinates in the query data 131 indicates the coordinates measured by the GPS measuring unit 204, and are expressed in latitude and longitude. The coordinates may have an error. The Velocity in the query data 131 indicates the velocity measured by the velocity measuring unit 205 at the time when the coordinates were measured.

The query data 131 includes data of a 5-minute period, for example. When the sampling interval is 10 seconds, the query data 131 contains data on a maximum of 30 query points. Some query points may be missing due to a failure of measurement by the GPS measuring unit 204.

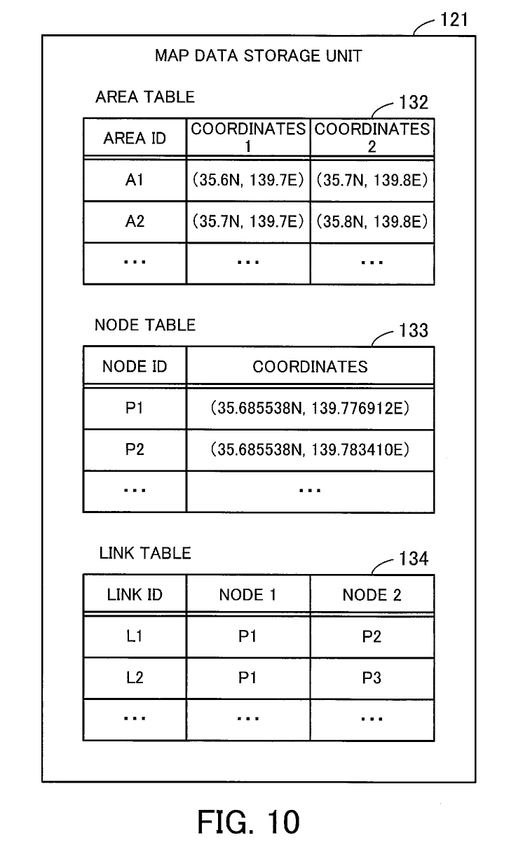

FIG. 10 illustrates an example of map data.

An area table 132 is stored in the map data storage unit 121. The area table 132 has the following items: Area ID, Coordinates 1, and Coordinates 2. The Area ID indicates the identifier assigned to each of areas obtained by splitting a road map into areas of about 10 kilometers×10 kilometers. The Coordinates 1 indicates the coordinates of one of four end points enclosing an area. The Coordinates 2 indicates the coordinates of an end point located diagonally to the end point indicated by the Coordinates 1. The Coordinates 1 and the Coordinates 2 are expressed in latitude and longitude. Note that the area table 132 may include four sets of coordinates of the four end points enclosing the area.

A node table 133 is stored in the map data storage unit 121. The node table 133 has the following items: Node ID and Coordinates. The Node ID indicates the identifier assigned to a basic point (intersection and the like) on a road on the road map. The Coordinates in the node table 133 indicates the coordinates of the position of a node, and are expressed in latitude and longitude.

A link table 134 is stored in the map data storing unit 121. The link table 134 has the following items: Link ID, Node 1, and Node 2. The Link ID indicates the identifier assigned to a link represented as a line connecting two nodes. The item Node 1 indicates the node ID assigned to the node at one end of the link. The item Node 2 indicates the node ID assigned to a node at the other end of the link.

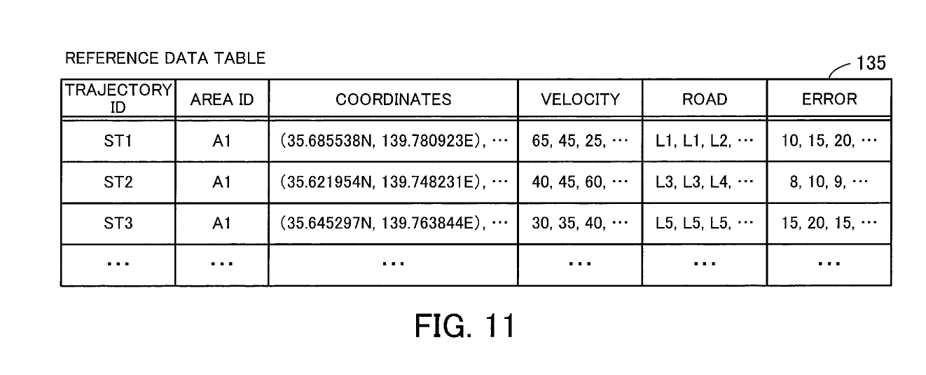

FIG. 11 illustrates an example of reference data.

A reference data table 135 is stored in the reference data storage unit 122. The reference data table 135 has the following items: Trajectory ID, Area ID, Coordinates, Velocity, Road, and Error. The Trajectory ID indicates the identifier assigned to a reference trajectory. The item Area ID indicates the identifier of an area to which a reference trajectory belongs, among the plurality of areas defined in the area table 132.

The item Coordinates lists the coordinates of the plurality reference points contained in the reference trajectory. For example, the item Coordinates lists the coordinates of 30 reference points corresponding to a 5-minute period. The coordinates of each reference point are expressed in latitude and longitude. The coordinates of each reference point are obtained by correcting the coordinates measured in the past, and indicate a point on a road. The item Velocity lists the velocities corresponding to the plurality of reference points. For example, the item Velocity lists 30 measured values of the velocities corresponding to 30 sets of coordinates. A velocity corresponding to a reference point is the velocity of the vehicle at the time of measurement of the coordinates before correction, and is measured by the same method as that used for the velocity at a query point.

The item Road lists the identifiers of roads corresponding to the plurality of reference points. For example, the item Road lists 30 identifiers of roads corresponding to 30 reference points. The link IDs defined in the link table 134 are used as the identifiers of roads. A road corresponding to a reference point is the road to which the reference point belongs, and is determined in previous map matching. The item Error lists the GPS measurement errors corresponding to the plurality of reference points. For example, the item Error lists 30 measurement errors corresponding to 30 reference points. An error corresponding to a reference point indicates the distance between the coordinates before correction and the coordinates after correction, and represents a GPS measurement error that occurred in the past. The error is expressed in meters.

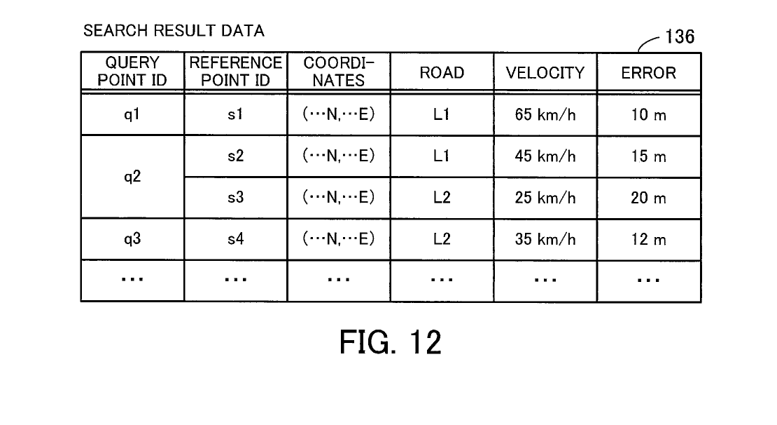

FIG. 12 illustrates an example of search result data.

Search result data 136 is generated by the similarity search unit 125. The search result data 136 has the following items: Query Point ID, Reference Point ID, Coordinates, Road, Velocity, and Error. The Query Point ID in the search result data 136 indicates the query point ID contained in the query data 131. The Reference Point ID indicates the identifier assigned to a reference point contained in the reference trajectory with the greatest similarity. Due to the nature of DTW, the query point IDs and the reference point IDs do not always correspond on a one-to-one basis. In some cases, two or more reference point IDs are associated with one query point ID. In other cases, two or more query point IDs are associated with one reference point ID. The items Coordinates, Road, Velocity, and Error respectively indicate the coordinates, velocity, road, and error extracted from the reference data table 135, in association with a reference point contained in the reference trajectory with the greatest similarity.

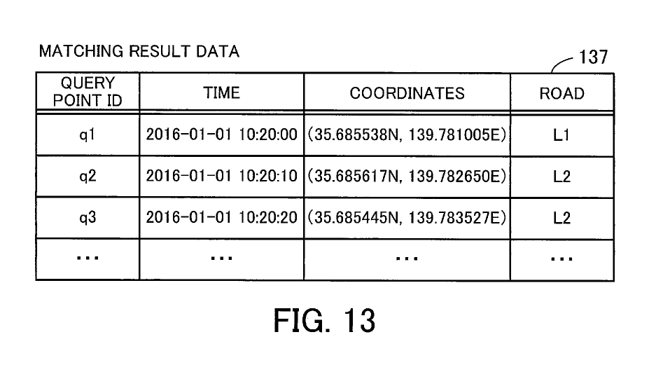

FIG. 13 illustrates an example of matching result data.

Matching result data 137 is generated by the road determining unit 126. The matching result data 137 has the following items: Query Point ID, Time, Coordinates, and Road. The Query Point ID, Time, and Coordinates in the matching result data 137 respectively correspond to the Query Point ID, Time, and Coordinates in the query data 131. The item Road indicates the identifier of a road (that is, the link ID) of a road with which each time is complemented by the road determining unit 126. The matching result data 137 allows to specify on which road the vehicle 20 was traveling at each time.

Note that in the second embodiment, the Velocity and Error in the reference data table 135 are not used for road determination. Accordingly, in the second embodiment, the Velocity and Error may be omitted from the reference data table 135. Likewise, in the second embodiment, the Velocity and Error may be omitted from the search result data 136. The Velocity in the reference data table 135 is used in a fifth embodiment described below. The Error in the reference data table 135 is used in a fourth embodiment described below.

The following describes the procedure of a process executed by the traffic analysis apparatus 100.

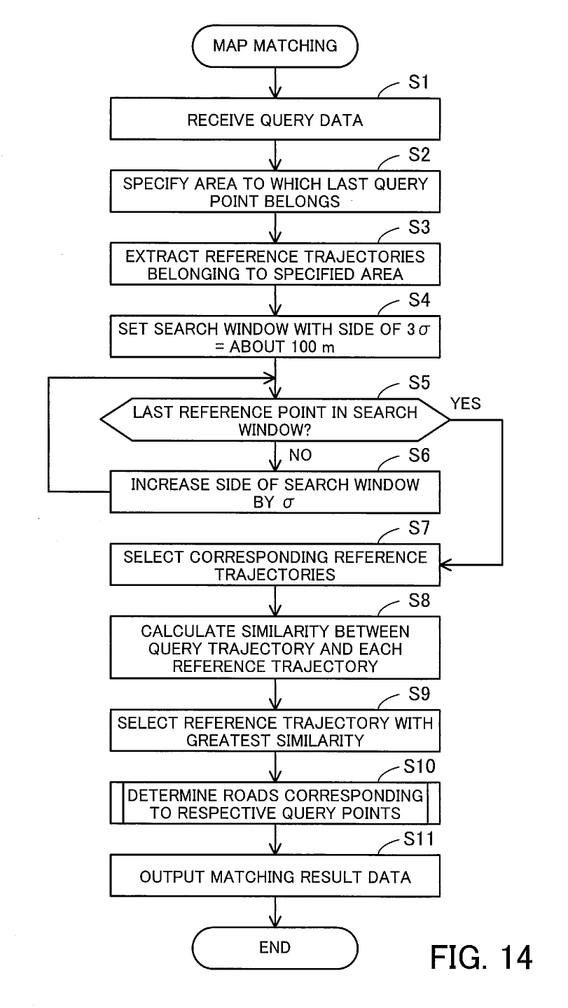

FIG. 14 is a flowchart illustrating an exemplary procedure of map matching.

(S1) The query data receiving unit 123 receives the query data 131 via the network 30 from a vehicle-mounted apparatus (for example, the vehicle-mounted apparatus 200 of the vehicle 20).

(S2) The reference data extracting unit 124 extracts a set of coordinates of the last query point (a set of coordinates of the last time), from among the plurality of sets of coordinates contained in the query data 131. The reference data extracting unit 124 specifies the area to which the last query point belongs, by referring to the area table 132 stored in the map data storage unit 121. The area to be specified is an area satisfying the condition that both the latitude and longitude of the coordinates of the query point are greater than those of “Coordinates 1” and less than those of “Coordinates 2”.

(S3) The reference data extracting unit 124 extracts a plurality of reference trajectories belonging to the specified area, from the reference data table 135 stored in the reference data storage unit 122.

(S4) The reference data extracting unit 124 sets a search window having its center at the last query point. The length of each side of the search window is 3σ=about 100 meters, where σ represents the standard deviation of a GPS measurement error.

(S5) The reference data extracting unit 124 determines whether there is one or more reference trajectories whose last reference point is in the search window. If there is one or more such reference trajectories, the process proceeds to step S7. If there is not such a reference trajectory, the processing proceeds to step S6.

(S6) The reference data extracting unit 124 increases the length of each side of the search window by σ. Then, the process returns to step S5, in which the reference data extracting unit 124 determines again whether there is one or more such reference trajectories.

(S7) The reference data extracting unit 124 selects the one or more reference trajectories whose last reference point is in the search window, from among the reference trajectories extracted in step S3. That is, the reference data extracting unit 124 selects one or more reference trajectories near the last query point.

(S8) The similarity search unit 125 calculates the similarity between the query trajectory indicated in the query data 131 and each of the reference trajectories selected in step S7. More specifically, the similarity search unit 125 calculates the DTW distance between a sequence of coordinates of the query points of the query data 131 and a sequence of reference points of the reference data table 135, by using the method described in FIG. 6.

(S9) The similarity search unit 125 selects the reference trajectory with the greatest similarity to the query trajectory, that is, the reference trajectory whose DTW distance calculated in step S8 is the smallest. Further, the similarity search unit 125 determines the corresponding relationships between the query points of the query trajectory and the reference points of the reference trajectory with the smallest DTW distance. The corresponding relationships between the query points and the reference points are determined in the course of calculating the DTW distance, by using the method described with reference to FIG. 6. The similarity search unit 125 generates the search result data 136 from the determined corresponding relationships and reference data on the selected reference trajectory (including the coordinates of each reference point, identifiers of roads, velocities, and errors).

(S10) The road determining unit 126 determines roads corresponding to the respective plurality of query points, based on the query data 131 and the search result data 136. The details of road determination will be described below.

(S11) The road determining unit 126 complements the query data 131 with the identifiers of the roads on which the vehicle-mounted apparatus that has transmitted the query data 131 was present, and generates the matching result data 137. The road determining unit 126 outputs the matching result data 137. The road determining unit 126 may display the matching result data 137 on the display 111. Further, the road determining unit 126 may store the matching result data 137.

The following describes road determination of step S10.

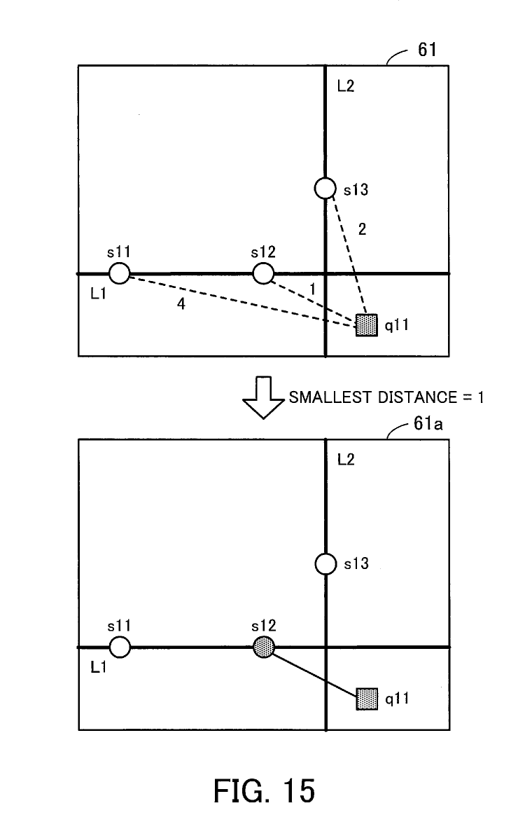

FIG. 15 illustrates a first example of selecting a reference point.

In the following, it is assumed that reference points s11, s12, and s13 are associated with a query point q11 by DTW. The reference points s11, s12, and s13 are points located near the query point call, and are candidates for the point corresponding to the query point q11.

As illustrated in a road map 61, the reference points s11 and s12 belong to a road L1. The reference point s13 belongs to a road L2. The query point q11 is not located on either of the roads L1 and L2 due to a GPS measurement error. The distance between the query point q11 and the reference point s11 is 4. The distance between the query point q11 and the reference point s12 is 1. The distance between the query point q11 and the reference point s13 is 2.

It is assumed here that the velocity of the vehicle 20 at the time of measurement of the query point q11 is sufficiently high. A sufficiently high velocity means that the GPS measurement error does not greatly affect the road determination, and that the unit moving distance=the sampling interval×the velocity is greater than the expected error. The unit moving distance is the distance that the vehicle 20 moves during a sampling interval (for example, a 10-second period). The expected error is the expected value of a GPS measurement error, and is set in advance to 10 meters, for example. If the unit moving distance is greater than the expected error, the distance to the adjacent query point and the distance to the adjacent reference point are prevented from becoming unrecognizable due to the GPS measurement error.

Accordingly, if the velocity corresponding to the query point q11 is sufficiently high, the reference point with the smallest distance from the query point q11 may be selected. In this example, as illustrated in a road map 61a, a reference point s12 is selected for the query point q11. Thus, the road L1 to which the reference point s12 belongs is associated with the query point q11.

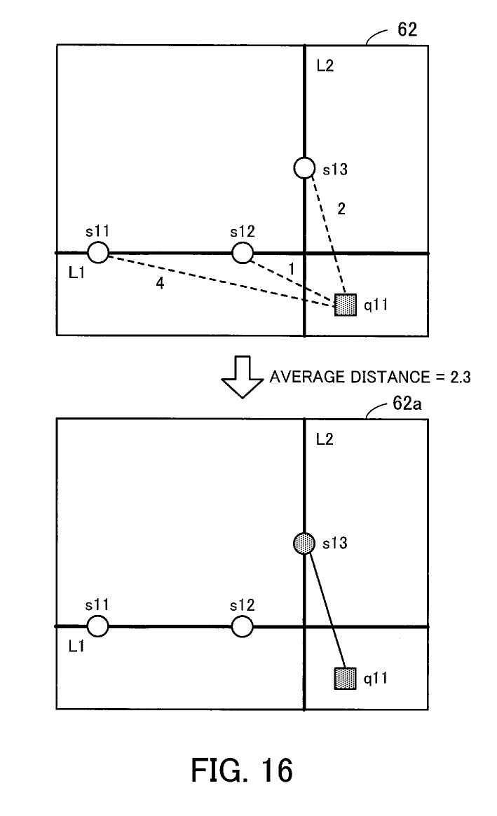

FIG. 16 illustrates a second example of selecting a reference point.

In the following, as in the case of FIG. 15, it is assumed that the reference points s11, s12, and s13 are associated with the query point q11 by DTW. As illustrated in a road map 62, the reference points s11 and s12 belong to the road L1. The reference point s13 belongs to the road L2. The distance between the query point q11 and the reference point s11 is 4. The distance between the query point q11 and the reference point s12 is 1. The distance between the query point q11 and the reference point s13 is 2.

It is assumed here that the velocity of the vehicle 20 at the time of measurement of the query point q11 is low. A low velocity means that the GPS measurement error greatly affects the road determination, and that the unit moving distance=the sampling interval×the velocity is equal to or less than the expected error. If the unit moving distance is equal to or less than the expected error, the distance to the adjacent query point and the distance to the adjacent reference point are not clearly recognized due to the GPS measurement error. In this case, when the GPS measurement error is taken into consideration, it is not appropriate to select the nearest reference point from the query point q11.

In view of the above, in the second embodiment, if the velocity corresponding to the query point q11 is low, the average distance between the query point q11 and each of the respective reference points s11, s12, and s13 is calculated. Then, the reference point whose distance from the query point q11 is the closest to the average distance is selected. In this example, the calculated average distance is 2.3. Then, as illustrated in a road map 62a, the reference point s13 is selected for the query point q11. Thus, the road L2 to which the reference point s13 belongs is associated with the query point q11. In this manner, if the velocity is low, the road nearest from the query point q11 is not always associated with the query point q11.

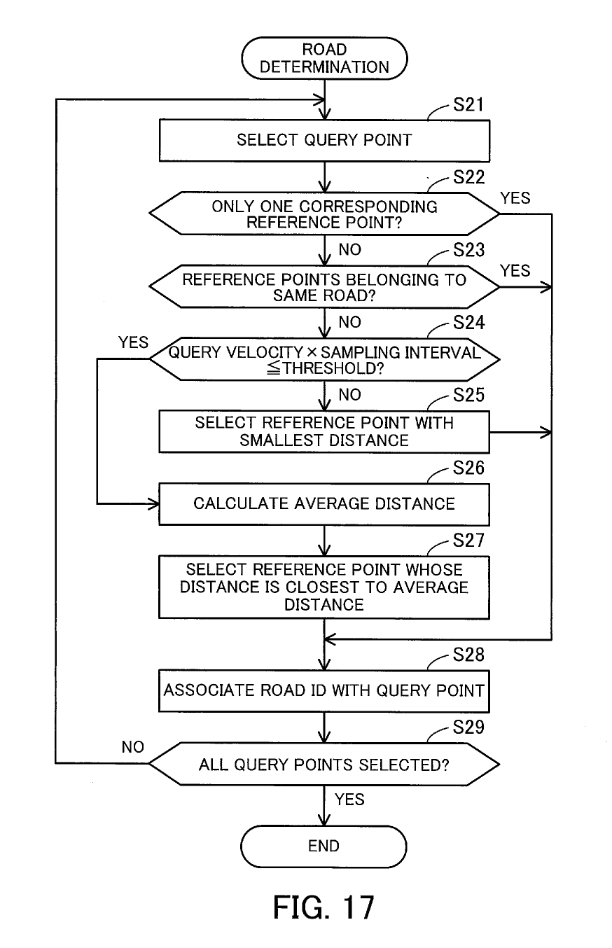

FIG. 17 is a flowchart illustrating a first exemplary procedure of road determination.

(S21) The road determining unit 126 selects a query point from the query data 131.

(S22) The road determining unit 126 searches the search result data 136 for a reference point corresponding to the query point selected in step S21, and determines whether there is only one corresponding reference point. If there is only one corresponding reference point, the process proceeds to step S28. If there are two or more corresponding reference points, the process proceeds to step S23.

(S23) The road determining unit 126 refers to the search result data 136 to determine whether the plurality of reference points found in step S22 belong to the same road, that is, whether the identifiers of the roads corresponding to the plurality of reference points are the same. If the plurality of reference points belong to the same road, the process proceeds to step S28. If not, the process proceeds to step S24.

(S24) The road determining unit 126 acquires a velocity (query velocity) corresponding to the query point selected in step S21, from the query data 131. The road determining unit 126 compares the query velocity×the sampling interval with a predetermined threshold, and determines whether the former is equal to or less than the latter. The sampling interval is the interval between query points contained in the query data 131. The vehicle-mounted apparatuses 200 and 200a sample the query points at predetermined sampling intervals. The threshold is the expected value of a GPS measurement error, and is set to meters, for example. If the query velocity×the sampling interval is less than or equal to the threshold, the process proceeds to step S26. If the query velocity×the sampling interval is greater than the threshold, the process proceeds to step S25.

(S25) The road determining unit 126 calculates the distance between the query point and each of the plurality of reference points. As the distance from the query point, the distance calculated by DTW may be used. The search result data 136 may include the distance from the query point. The road determining unit 126 selects the reference point with the smallest distance, from among the plurality of reference points. Then, the process proceeds to step S28.

(S26) The road determining unit 126 calculates the distance between the query point and each of the plurality of reference points. The road determining unit 126 calculates the average distance for the plurality of reference points.

(S27) The road determining unit 126 selects the reference point whose distance is the closest to the average distance, from among the plurality of reference points. The closest distance to the average distance indicates, for example, the distance whose absolute value of the difference from the average distance is the smallest among those of the plurality of reference points. Then, the process proceeds to step S28.

(S28) The road determining unit 126 associates a single road identifier with the query point selected in step S21. The road identifier to be associated is the identifier of the road to which the reference point corresponding to the query point belongs, among the identifiers of roads contained in the search result data 136. If there are a plurality of candidate road identifiers, the road determining unit 126 uses the identifier of the road to which the reference point selected in the above step S25 or step S27 belongs.

(S29) The road determining unit 126 determines whether all the query points contained in the query data 131 have been selected in step S21. If all the query points have been selected, the road determination ends. If there is any unselected query point, the process returns to step S21.

In the case where two reference points correspond to the query point, both the two reference points are selected as the reference points with the closest distance to the average distance in step S27. In this case, the road determining unit 126 may select one of the reference points that is nearer from the query point in the same manner as in step S25. Alternatively, the road determining unit 126 may select one of the reference points by using a method of the fourth embodiment described below. Further, the road determining unit 126 may narrow down reference points by using a method of the fifth embodiment described below.

In the second embodiment, the vehicle-mounted apparatuses 200 and 200a measure the velocity. However, the velocity may be estimated from the distance between adjacent query points and the difference in measurement time. In this case, the query data 131 does not have to include the velocity. Further, the road determining unit 126 estimates the velocity corresponding to each query point from the coordinates and time contained in the query data 131, and uses the estimated velocity in the above step S24.

According to the traffic analysis system of the second embodiment, the query data 131 associating times with GPS coordinates is complemented with road identifiers by map matching. This makes it possible to specify a single road on which the vehicle 20 was traveling at each time.

Further, in the case where a plurality of candidate reference points are output for a single query point by similarity search using DTW, one of the reference points is selected by using different methods depending on the velocity of the vehicle 20 at the query point. In the second embodiment, if the vehicle 20 was moving at a high speed, the nearest reference point from the query point is selected. On the other hand, if the vehicle 20 was moving at a low speed, the reference point whose distance from the query point is the closest to the average distance is selected. That is, in the case where the vehicle 20 was moving at a low speed, even if the nearest reference point from the query point is selected, the reliability of corresponding relationship is determined to be low. Accordingly, by taking into consideration the GPS measurement error, it is possible to appropriately associate a road on which the vehicle 20 was present with each time of measurement of the coordinates.

### (c) Third Embodiment

The following describes a third embodiment.

A traffic analysis system of the third embodiment is different from that of the second embodiment in the method of determining a road in the case where the velocity is low. The traffic analysis system of the third embodiment may be implemented with the same configuration as that of the traffic analysis system of the second embodiment illustrated in FIGS. 2 to 4 and 8 to 13. In the following, the third embodiment will be described using the same reference numbers as those used in FIGS. 2 to 4 and 8 to 13.

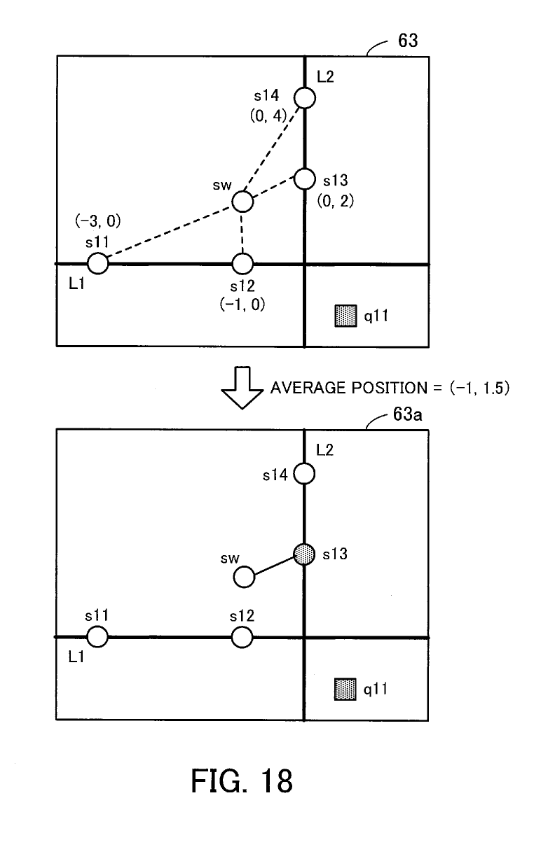

FIG. 18 illustrates a third example of selecting a reference point.

In the following, it is assumed that the reference points s11, s12, s13, and s14 are associated with the query point q11 by DTW. The reference points s11, s12, s13 and s14 are points located near the query point call, and are candidates for the point corresponding to the query point q11.

As illustrated in a road map 63, the reference points s11 and s12 belong to the road L1. The reference points s13 and s14 belong to the road L2. The coordinates of the reference point s11 are (−3, 0); the coordinates of the reference point s12 are (−1, 0); the coordinates of the reference point s13 are (0, 2); and the coordinates of the reference point s14 are (0, 4). The query point q11 is not located on either of the roads L1 and L2.

It is assumed here that the velocity of the vehicle 20 at the time of measurement of the query point q11 is low. As in the second embodiment, a low velocity means that the unit moving distance=the sampling interval×the velocity is equal to or less than the expected error. In this case, when the GPS measurement error is taken into consideration, it is not appropriate to select the nearest reference point from the query point q11.

In view of the above, in the third embodiment, if the velocity corresponding to the query point q11 is low, an average position sw of the reference points s11, s12, s13, and s14 is calculated. Then, the nearest reference point to the average position sw is selected from among the reference points s11, s12, s13, and s14. In this example, the calculated coordinates of the average position sw are (−1, 1.5). Then, as illustrated in a road map 63a, the reference point s13 that is the nearest to the average position sw is selected. Thus, the road L2 to which the reference point s13 belongs is associated with the query point q11.

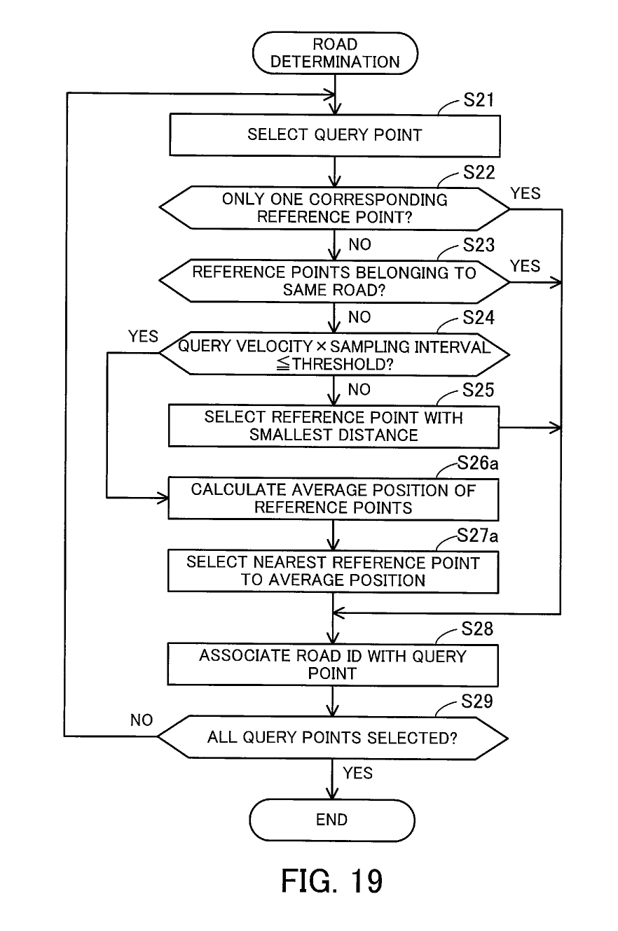

FIG. 19 is a flowchart illustrating a second exemplary procedure of road determination.

Steps S21 to S25, S28, and S29 of the flowchart of FIG. 19 are the same as those of the flowchart of the second embodiment illustrated in FIG. 17, and will not be described below. Steps S26a and S27a described below are performed in place of steps S26 and S27 of the second embodiment.

(S26a) The road determining unit 126 calculates the average position of the plurality of reference points. For example, the latitude of the average position is obtained by dividing the sum of the latitudes of the plurality of reference points by the number of reference points. The longitude of the average position is obtained by dividing the sum of the longitudes of the plurality of reference points by the number of reference points.

(S27a) The road determining unit 126 calculates the distance between the average position calculated in step S26a and each of the plurality of reference points. Then, the road determining unit 126 selects the reference point whose distance from the average position is the smallest (the nearest reference point to the average position), from among the plurality of reference points.

In the case where two reference points correspond to the query point, both the two reference points are selected as the nearest reference points to the average position in step S27a. In this case, the road determining unit 126 may select one of the reference points that is nearer from the query point in the same manner as in step S25. Alternatively, the road determining unit 126 may select one of the reference points by using the method of the fourth embodiment described below. Further, the road determining unit 126 may narrow down reference points by using the method of the fifth embodiment described below.

According to the traffic analysis system of the third embodiment, as in the second embodiment, it is possible to specify a single road on which the vehicle 20 was traveling at each time. Further, in the case where a plurality of candidate reference points are output by similarity search using DTW, one of the reference points is selected by using different methods depending on the velocity of the vehicle 20. In the third embodiment, if the vehicle 20 was moving at a low speed, the nearest reference point to the average position is selected. That is, in the case where the vehicle 20 was moving at a low speed, even if the nearest reference point from the query point is selected, the reliability of corresponding relationship is determined to be low. Accordingly, by taking into consideration the GPS measurement error, it is possible to appropriately associate a road on which the vehicle 20 was present with each time of measurement of the coordinates.

### (d) Fourth Embodiment

The following describes the fourth embodiment.

A traffic analysis system of the fourth embodiment is different from those of the second and third embodiments in the method of determining a road in the case where the velocity is low. The traffic analysis system of the fourth embodiment may be implemented with the same configuration as that of the traffic analysis system of the second embodiment illustrated in FIGS. 2 to 4 and 8 to 13. In the following, the fourth embodiment will be described using the same reference numbers as those used in FIGS. 2 to 4 and 8 to 13.

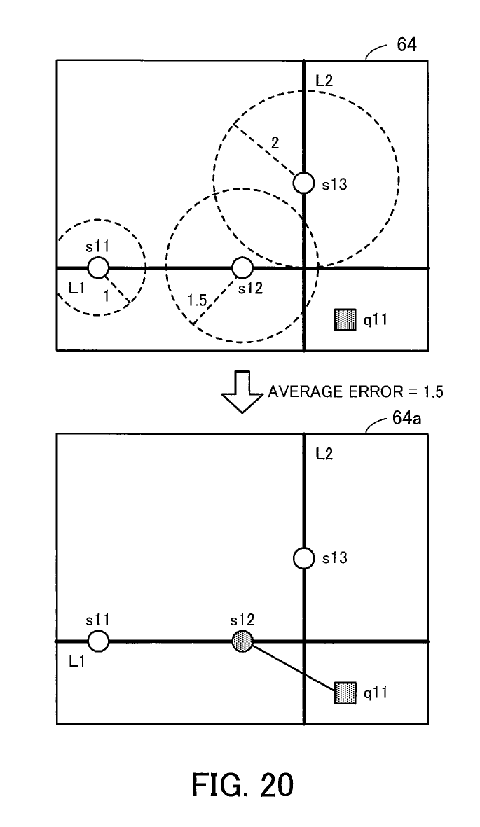

FIG. 20 illustrates a fourth example of selecting a reference point.

In the following, it is assumed that the reference points s11, s12, and s13 are associated with the query point q11 by DTW. The reference points s11, s12, and s13 are points located near the query point call, and are candidates for the point corresponding to the query point q11.

As illustrated in a road map 64, the reference points s11 and s12 belong to the road L1. The reference point s13 belongs to the road L2. The query point q11 is not located on either of the roads L1 and L2. The reference data table 135 and the search result data 136 indicate an error “1” for the reference point s11, an error “1.5” for the reference point s12; and an error “2” for the reference point s13.

Accordingly, the distance between the reference point s11 (point after correction) and its corresponding measured point (point before correction) is “1”, that is, an error of “1” occurred in the vicinity of the reference point s11 in the past. Likewise, the distance between the reference point s12 (point after correction) and its corresponding measured point (point before correction) is “1.5”, that is, an error of “1.5” occurred in the vicinity of the reference point s12 in the past. Likewise, the distance between the reference point s13 (point after correction) and its corresponding measured point is “2”, that is, an error of “2” occurred in the vicinity of the reference point s13 in the past.

It is assumed here that the velocity of the vehicle 20 at the time of measurement of the query point q11 is low. As in the second embodiment, a low velocity means that the unit moving distance=the sampling interval×the velocity is equal to or less than the expected error. In this case, when the GPS measurement error is taken into consideration, it is not appropriate to select the nearest reference point from the query point q11.

In view of the above, in the fourth embodiment, if the velocity corresponding to the query point q11 is low, the average of errors (average error) that occurred in the past to the reference points s11, s12, and s13 is calculated. Further, the distance from the query point q11 is calculated for each of the reference points s11, s12, and s13. Then, the reference point whose distance is the closest to the average error is selected from among the reference points s11, s12, and s13. In this example, the calculated average error is “1.5”. Then, as illustrated in a road map 64a, the reference point s12 whose distance from the query point q11 is the closest to the average error is selected. Thus, the road L1 to which the reference point s12 belongs is associated with the query point q11.

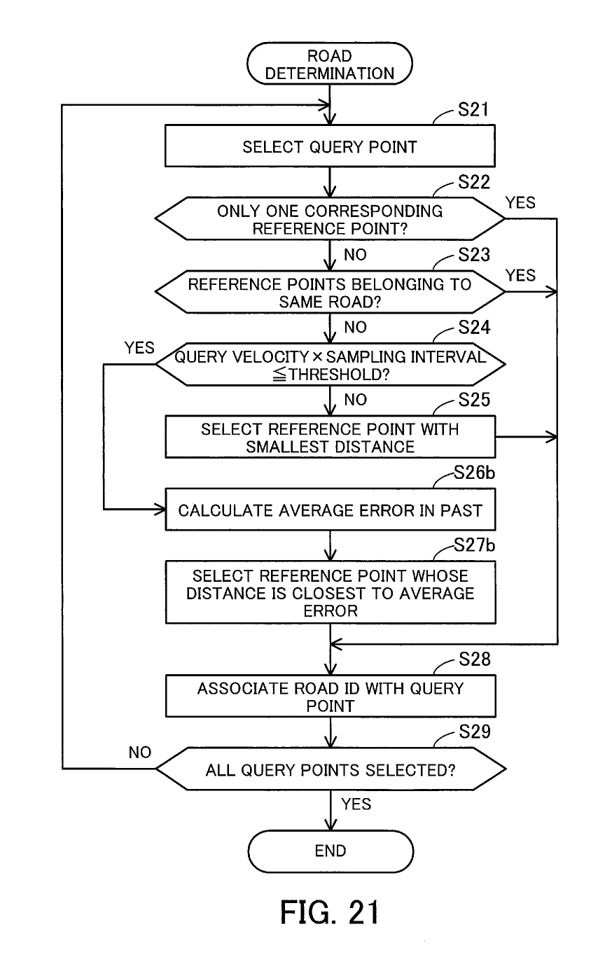

FIG. 21 is a flowchart illustrating a third exemplary procedure of road determination.

Steps S21 to S25, S28, and S29 of the flowchart of FIG. 21 are the same as those of the flowchart of the second embodiment illustrated in FIG. 17, and will not be described below. Steps S26b and S27b described below are performed in place of steps S26 and S27 of the second embodiment.

(S26b) The road determining unit 126 calculates the distance between the query point and each of the plurality of reference points. The road determining unit 126 acquires errors corresponding to the respective plurality of reference points from the search result data 136, and calculates the average error as the average of the acquired errors.

(S27b) The road determining unit 126 may select the reference point whose distance is the closest to the average error, from among the plurality of reference points. The closest distance to the average error indicates, for example, the distance whose absolute value of the difference from the average error is the smallest among those of the plurality of reference points.

Note that in the above, the reference data table 135 and the search result data 136 indicate an error for each reference point. However, the reference data table 135 and the search result data 136 may indicate a single average error for each reference trajectory. The average error of a certain reference trajectory indicates the average of errors of all the reference points contained in the certain reference trajectory. This makes it possible to reduce the workload of creating the reference data and reduce the amount of reference data. In this case, the road determining unit 126 may use the average error contained in the search result data 136, without calculating the average error in step S26b.

According to the traffic analysis system of the fourth embodiment, as in the second and third embodiments, it is possible to specify a single road on which the vehicle 20 was traveling at each time. Further, in the case where a plurality of candidate reference points are output by similarity search using DTW, one of the reference points is selected by using different methods depending on the velocity of the vehicle 20. In the fourth embodiment, if the vehicle 20 was moving at a low speed, the reference point whose distance from the query point is the closest to the average error is selected. That is, in the case where the vehicle 20 was moving at a low speed, even if the nearest reference point from the query point is selected, the reliability of corresponding relationship is determined to be low. Accordingly, by taking into consideration the GPS measurement error, it is possible to appropriately associate a road on which the vehicle 20 was present with each time of measurement of the coordinates.

### (e) Fifth Embodiment

The following describes the fifth embodiment.

A traffic analysis system of the fifth embodiment is different from those of the second, third, and fourth embodiments in that the reference points are narrowed down in the case where the velocity is low. A method of narrowing down the reference points according to the fifth embodiment may be used in combination of road determination of any of the second, third, and fourth embodiments. The traffic analysis system of the fifth embodiment may be implemented with the same configuration as that of the traffic analysis system of the second embodiment illustrated in FIGS. 2 to 4 and 8 to 13. In the following, the fifth embodiment will be described using the same reference numbers as those used in FIGS. 2 to 4 and 8 to 13.

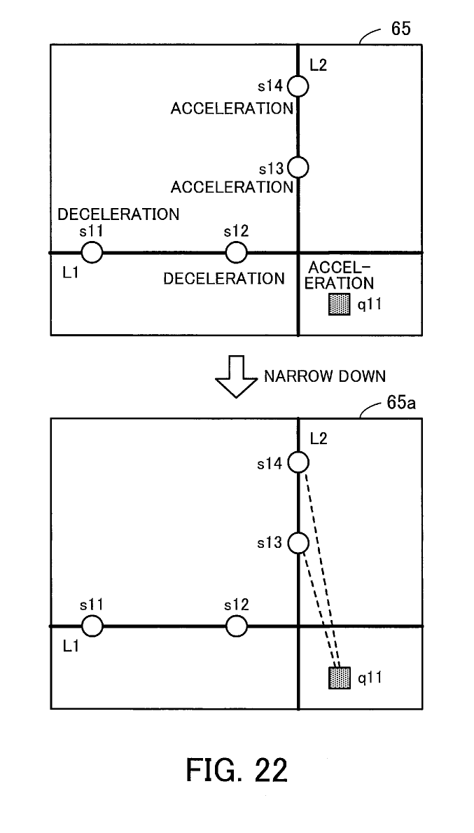

FIG. 22 illustrates a fifth example of selecting a reference point.

In the following, it is assumed that the reference points s11, s12, s13, and s14 are associated with the query point q11 by DTW. The reference points s11, s12, s13 and s14 are points located near the query point q11, and are candidates for the point corresponding to the query point q11.

As illustrated in a road map 65, the reference points s11 and s12 belong to the road L1. The reference points s13 and s14 belong to the road L2. The vehicle decelerated at the reference points s11 and s12. The vehicle accelerated at the reference points s13 and s14. The presence or absence of acceleration at a certain reference point may be determined by comparing the velocity at the certain reference point with the velocity at the preceding or following reference point. The velocity at each reference point is indicated in the reference data table 135 and the search result data 136.

Further, the query point q11 is not located on either of the roads L1 and L2. The vehicle accelerated at the query point q11. The presence or absence of acceleration at a certain query point may be determined by comparing the velocity at the certain query point with the velocity at the preceding or following query point. The velocity at each query point is indicated in the query data 131.

It is assumed here that the velocity of the vehicle 20 at the time of measurement of the query point q11 is low. As in the second embodiment, a low velocity means that the unit moving distance=the sampling interval×the velocity is equal to or less than the expected error. In this case, when the GPS measurement error is taken into consideration, it is not appropriate to select the nearest reference point from the query point q11. In view of the above, if the velocity corresponding to the query point q11 is low, a single reference point corresponding to the query point q11 is selected by using any of the methods of the second, third, and fourth embodiments.

Note that in the fifth embodiment, selectable candidates are narrowed down before selecting a single reference point. In the fifth embodiment, the presence or absence of acceleration at the query point q11 is compared with the presence or absence of acceleration at each of the reference points s11, s12, s13, and s14. Then, the reference point that does not match the query point q11 in terms of the presence or absence of acceleration is excluded from the selectable candidates. In this example, the reference points s11 and s12 do not match the query point q11 in terms of the presence or absence of acceleration, while the reference points s13 and s14 match the query point q11 in terms of the presence or absence of acceleration. Accordingly, as illustrated in a road map 65a, the selectable candidates are narrowed down to the reference points s13 and s14. Both the reference points s13 and s14 belong to the road L2, and hence the road L2 is associated with the query point q11.

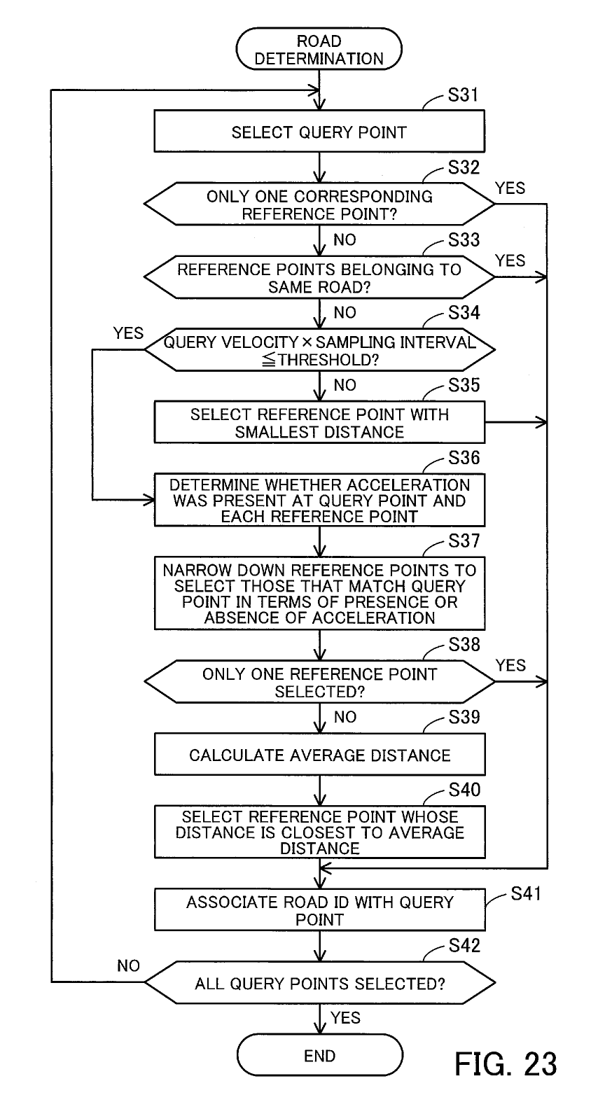

FIG. 23 is a flowchart illustrating a fourth exemplary procedure of road determination.

Steps S31 to S35, S41, and S42 of the flowchart of FIG. 23 are the same as steps S21 to S25, S28 and S29 of the flowchart of the second embodiment illustrated in FIG. 17, and will not be described below.

(S36) The road determining unit 126 determines whether acceleration was present at the query point selected in step S31. For example, the road determining unit 126 compares the velocity at the selected query point with the velocity at the immediately preceding query point. If the former is greater than the latter, the road determining unit 126 determines that acceleration was present. If not, the road determining unit 126 determines that deceleration was present. Further, the road determining unit 126 acquires velocities at the plurality of reference points from the search result data 136, and determines whether acceleration was present at each of the plurality of reference points. For example, the road determining unit 126 compares the velocity at a certain reference point with the velocity at the immediately preceding reference point. If the former is greater than the latter, the road determining unit 126 determines that acceleration was present. If not, the road determining unit 126 determines that deceleration was present.

(S37) The road determining unit 126 narrows down a plurality of reference points to select those that match the query point in terms of the presence or absence of acceleration. In the case where “acceleration” is determined at the query point, the road determining unit 126 selects reference points where “acceleration” is determined. In the case where “deceleration” is determined at the query point, the road determining unit 126 selects reference points where “deceleration” is determined.

(S38) the road determining unit 126 determines whether only one reference point is selected in step S37. If only one reference point is selected, the process proceeds to step S41. If two or more reference points are selected, the process proceeds to step S39.

(S39) The road determining unit 126 calculates the distance between the query point and each of the selected reference points. The road determining unit 126 calculates the average distance for the plurality of reference points.

(S40) The road determining unit 126 selects the reference point whose distance is the closest to the average distance, from among the selected reference points. The closest distance to the average distance indicates, for example, the distance whose absolute value of the difference from the average distance is the smallest. Then, the process proceeds to step S41.

Note that in the flowchart of FIG. 23, the method used in the second embodiment is used to select a single reference point after narrowing down the reference points. However, the method used in the third embodiment or the fourth embodiment may be used. In this case, processing in the above steps S39 and S40 are changed.

According to the traffic analysis system of the fifth embodiment, the same effects as those of the second to fourth embodiments are obtained. Further, in the fifth embodiment, a plurality of query points and a plurality of reference points are associated such that their vehicle driving patterns match each other. Accordingly, it is possible to more appropriately associate a road on which the vehicle 20 was present with each time.

As mentioned above, the information processing in the first embodiment may be implemented by causing the information processing apparatus 10 to execute a program.

The information processing in the second to fifth embodiments may be implemented by causing the traffic analysis apparatus 100 and the vehicle-mounted apparatuses 200 and 200a to execute a program.

Each program may be recorded in a computer-readable storage medium (for example, the storage medium 113 or 211). Examples of storage media include magnetic disks, optical discs, magneto-optical disks, semiconductor memories, and the like. Examples of magnetic disks include FD and HDD. Examples of optical discs include CD, CD-Recordable (CD-R), CD-Rewritable (CD-RW), DVD, DVD-R, and DVD-RW. The program may be stored in a portable storage medium and distributed. In this case, the program may be executed after being copied from the portable storage medium to another storage medium (for example, the HDD 103 or the non-volatile memory 203).

According to one aspect, it is possible to associate a road on which a moving object was present with each time.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory configured to store second trajectory data and road data, the second trajectory data indicating a plurality of reference positions, the road data indicating which of two or more roads each of the plurality of reference positions belongs to; and
a processor configured to perform a procedure including:
acquiring first trajectory data and velocity data, the first trajectory data associating a plurality of times with a plurality of measured positions of a moving object, the velocity data indicating a moving velocity of the moving object at each of the plurality of times,
detecting a first measured position where the moving velocity is equal to or less than a threshold, from among the plurality of measured positions indicated in the first trajectory data, based on the velocity data,
extracting two or more reference positions located in a predetermined range from the first measured position, from among the plurality of reference positions indicated in the second trajectory data, and
complementing the first trajectory data with information on roads corresponding to the respective times, by determining which of the two or more roads is to be associated with a time of measurement of the first measured position, based on the extracted two or more reference positions and the road data.

2. The information processing apparatus according to claim 1, the procedure further includes, for a second measured position of the plurality of measured positions where the moving velocity is greater than the threshold, selecting a first reference position nearest from the second measured position, and associating a road to which the first reference position belongs with a time of measurement of the second measured position.

3. The information processing apparatus according to claim 1, wherein the complementing includes calculating, for each of the two or more reference positions, a distance from the first measured position, selecting a first reference position whose distance is closest to an average value of the distance, from among the two or more reference positions, and associating a road to which the first reference position belongs with a time of measurement of the first measured position.

4. The information processing apparatus according to claim 1, wherein the complementing includes calculating an average position of the two or more reference positions, selecting a first reference position nearest to the average position, from among the two or more reference positions, and associating a road to which the first reference position belongs with a time of measurement of the first measured position.

5. The information processing apparatus according to claim 1, wherein:
the memory is configured to further store error data indicating a measurement error that occurs at each of the plurality of reference positions; and
the complementing includes calculating, for each of the two or more reference positions, a distance from the first measured position, selecting a first reference position whose distance is closest to the measurement error indicated in the error data, from among the two or more reference positions, and associating a road to which the first reference position belongs with a time of measurement of the first measured position.

6. A trajectory information generating method comprising:
acquiring, by a processor, first trajectory data and velocity data, the first trajectory data associating a plurality of times with a plurality of measured positions of a moving object, the velocity data indicating a moving velocity of the moving object at each of the plurality of times;
acquiring, by the processor, from a database, second trajectory data and road data, the second trajectory data indicating a plurality of reference positions, the road data indicating which of two or more roads each of the plurality of reference positions belongs to;
detecting, by the processor, a first measured position where the moving velocity is equal to or less than a threshold, from among the plurality of measured positions indicated in the first trajectory data, based on the velocity data;
extracting, by the processor, two or more reference positions located in a predetermined range from the first measured position, from among the plurality of reference positions indicated in the second trajectory data; and
complementing, by the processor, the first trajectory data with information on roads corresponding to the respective times, by determining which of the two or more roads is to be associated with a time of measurement of the first measured position, based on the extracted two or more reference positions and the road data.

7. A non-transitory computer-readable storage medium storing a computer program that causes a computer to perform a procedure comprising:
acquiring first trajectory data and velocity data, the first trajectory data associating a plurality of times with a plurality of measured positions of a moving object, the velocity data indicating a moving velocity of the moving object at each of the plurality of times;
acquiring, from a database, second trajectory data and road data, the second trajectory data indicating a plurality of reference positions, the road data indicating which of two or more roads each of the plurality of reference positions belongs to;
detecting a first measured position where the moving velocity is equal to or less than a threshold, from among the plurality of measured positions indicated in the first trajectory data, based on the velocity data;
extracting two or more reference positions located in a predetermined range from the first measured position, from among the plurality of reference positions indicated in the second trajectory data; and
complementing the first trajectory data with information on roads corresponding to the respective times, by determining which of the two or more roads is to be associated with a time of measurement of the first measured position, based on the extracted two or more reference positions and the road data.
